(19) United States
(12) Patent Application Publication
(10) Pub. No.: US 2025/0069401 A1
(43) Pub. Date: Feb. 27, 2025

(54) SYSTEMS AND METHODS OF IMAGE ANALYSIS FOR AUTOMATED OBJECT LOCATION DETECTION AND MANAGEMENT

(71) Applicant: NAVTRAC CORP., West Hollywood, CA (US)

(72) Inventors: John Baron DANIELS, West Hollywood, CA (US); Mihail Nikolaevich PIVTORAIKO, West Hollywood, CA (US)

(21) Appl. No.: 18/723,279

(22) PCT Filed: Dec. 22, 2022
(86) PCT No.: PCT/US2022/082203

§ 371 Date: Jun. 21, 2024

Related U.S. Application Data
(60) Provisional application No. 63/293,575, filed on Dec. 23, 2021.

(51) Int. Cl. G06V 20/52; G06Q 10/087; G06V 10/75; G06V 10/764; G06V 10/774

(52) U.S. Cl. CPC G06V 20/52; G06Q 10/087; G06V 10/751; G06V 10/764; G06V 10/774; G06V 2201/06; G06V 2201/08

(57) ABSTRACT

Systems and methods for automating the management of a warehouse are disclosed. The method includes monitoring. in real-time, a plurality of items in the warehouse, a plurality of tasks associated with the warehouse, and/or incoming vehicles to the warehouse. The method also includes receiving, via a plurality of sensors, image data and/or video data associated with the plurality of items, the plurality of tasks, and/or the incoming vehicles. The method further includes inputting the image data and/or the video data into a machine learning model to automate the management of the warehouse, wherein the machine learning model has been trained based on training data to generate predictions for the inputted data, and wherein the machine learning model utilizes the predictions for the inputted data for retraining to generate predictions for newly inputted data and improve accuracy of error handling.

### RELATED APPLICATION

This application claims the benefit of priority to U.S. Provisional Application No. 63/293,575, filed on Dec. 23, 2021, which is hereby incorporated herein by reference in its entirety.

### TECHNICAL FIELD

The present disclosure relates generally to the field of image analysis for automated object location detection and management and, more particularly, to machine vision and artificial intelligence (Al) based automated systems for yard, warehouse, and port management.

### BACKGROUND

Warehouse, shipping yard, and port management is becoming increasingly important with the heightened increase in demands, technological advancements, and competition. Warehouses, shipping yards, and ports are under intensified pressure to expedite order fulfillment and optimize their operations, but outdated technology and inefficient processes hinder their growth. For example, products are sold in increasingly voluminous quantities, models, and configurations, and they are continually added to and removed from warehouses, making manually monitoring product inventory and tracking product position error-prone, expensive, and time-consuming. The traditional warehouse management system operates in a non-automated manner and involves a large number of manually conducted tasks that do not scale well when manual resources are limited. Accordingly, service providers face significant technical challenges in managing warehouse space with thousands of dollars in assets, large employee team, and people/vehicles continuously entering and exiting the premises.

Therefore, there is a need for image analysis for automated object location detection and management, and more particularly for an approach for automating warehouse management using machine learning and artificial intelligence (Al) for increasing accuracy and security and reducing costs.

### SUMMARY

According to certain aspects of the present disclosure, systems and methods are disclosed for automating management of a warehouse.

In one embodiment, a computer-implemented method for automating management of a warehouse is disclosed. The computer-implemented method includes: monitoring, in real-time, a plurality of items in the warehouse, a plurality of tasks associated with the warehouse, and/or incoming vehicles to the warehouse; receiving, via a plurality of sensors, image data and/or video data associated with the plurality of items, the plurality of tasks, and/or the incoming vehicles, wherein the image data and/or the video data indicates a change in position of at least one of the plurality of items, at least one incomplete task from the plurality of tasks, and/or a change in location of at least one of the incoming vehicles; and inputting the image data and/or the video data into a machine learning model to automate the management of the warehouse, wherein the machine learning model has been trained based on training data to generate predictions for the inputted data, and wherein the machine learning model utilizes the predictions for the inputted data for retraining to generate predictions for newly inputted data and improve accuracy of error handling.

In accordance with another embodiment, a system for automating management of a warehouse is disclosed. The system includes monitoring, in real-time, a plurality of items in the warehouse, a plurality of tasks associated with the warehouse, and/or incoming vehicles to the warehouse; receiving, via a plurality of sensors, image data and/or video data associated with the plurality of items, the plurality of tasks, and/or the incoming vehicles, wherein the image data and/or the video data indicates a change in position of at least one of the plurality of items, at least one incomplete task from the plurality of tasks, and/or a change in location of at least one of the incoming vehicles; and inputting the image data and/or the video data into a machine learning model to automate the management of the warehouse, wherein the machine learning model has been trained based on training data to generate predictions for the inputted data, and wherein the machine learning model utilizes the predictions for the inputted data for retraining to generate predictions for newly inputted data and improve accuracy of error handling.

In accordance with a further embodiment, non-transitory computer readable medium for automating management of a warehouse is disclosed. The non-transitory computer readable medium storing instructions which, when executed by one or more processors, cause the one or more processors to perform operations, comprising: monitoring, in real-time, a plurality of items in the warehouse, a plurality of tasks associated with the warehouse, and/or incoming vehicles to the warehouse; receiving, via a plurality of sensors, image data and/or video data associated with the plurality of items, the plurality of tasks, and/or the incoming vehicles, wherein the image data and/or the video data indicates a change in position of at least one of the plurality of items, at least one incomplete task from the plurality of tasks, and/or a change in location of at least one of the incoming vehicles; and inputting the image data and/or the video data into a machine learning model to automate the management of the warehouse, wherein the machine learning model has been trained based on training data to generate predictions for the inputted data, and wherein the machine learning model utilizes the predictions for the inputted data for retraining to generate predictions for newly inputted data and improve accuracy of error handling.

It is to be understood that both the foregoing general description and the following detailed description are exemplary and explanatory only and are not restrictive of the detailed embodiments, as claimed.

### BRIEF DESCRIPTION OF THE DRAWINGS

The embodiments of the invention are illustrated by way of example, and not by way of limitation, in the figures of the accompanying drawings:

FIG. 1 is a diagram of a system capable of tracking inventory items associated with a warehouse system and performing real-time surveillance of the warehouse facility, according to one embodiment;

FIG. 2A is a diagram of the components of an exemplary machine learning system of the system of FIG. 1, according to one example embodiment;

FIG. 2B is a flowchart of a process for automating the management of a warehouse, according to one example embodiment;

FIGS. 3A-3E are diagrams illustrating real-time detection and identification of at least one vehicle approaching a warehouse facility, according to one embodiment;

FIGS. 3F-3G are diagrams that illustrate automated management of a plurality of packages inside a warehouse facility, according to one embodiment;

FIGS. 3H-3L are diagrams that illustrate real-time detection and identification of at least one vehicle leaving a warehouse facility, according to one embodiment;

FIG. 4A-4D are electronic user interface diagrams that illustrate monitoring and recording incoming/outgoing vehicles to a warehouse facility, according to one embodiment;

FIG. 4E is an electronic user interface diagram that illustrates an online check-in process by a user, e.g., a driver, of at least one vehicle in the warehouse facility, according to one embodiment;

FIGS. 4F-41 are electronic user interface diagrams that illustrate an online process for assigning a parking space for a vehicle associated with the checked-in driver, according to one embodiment;

FIGS. 4J-4K are electronic user interface diagrams that depict appointment confirmation and a QR code enabled check-in process, according to one example embodiment;

FIG. 5 illustrates an implementation of a general computer system that may execute techniques presented herein; and

FIG. 6 shows an example machine learning training flow chart.

### DETAILED DESCRIPTION OF EMBODIMENTS

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

Existing methods and systems for warehouse management are error-prone, time-consuming, and inefficient. Existing systems operate on a manual recording of inventory resulting in errors, lack of transparency, loss in revenue, and a large amount of time spent reconciling issues. Typically, to illustrate one example context for the present disclosure, a transportation company may contract with a warehouse facility for the transportation of goods. The transportation company may send a vehicle, e.g., a truck, to deliver or take away goods from the warehouse facility. The driver of the vehicle may have to wait for a longer time at the entrance of the warehouse facility because of manual verification, manual security check-in, and manual recordation of visitors, e.g., using a paper and pen system. Such labor-intensive system is inefficient, time-consuming, and error-prone. Hence, service providers face significant technical challenges in providing a system that implements real-time data to automate the security and surveillance at a warehouse facility.

In another example application for the present disclosure, a warehouse employee may attempt to retrieve a product from an expected location but the product might be misplaced, hence time and effort are wasted making physical checks and trying to correct the error, often leading to delayed shipments. Service providers face significant technical challenges in providing a system that detects and records in real-time the geographical location of assets within a warehouse or assets estimated to arrive at the warehouse facility.

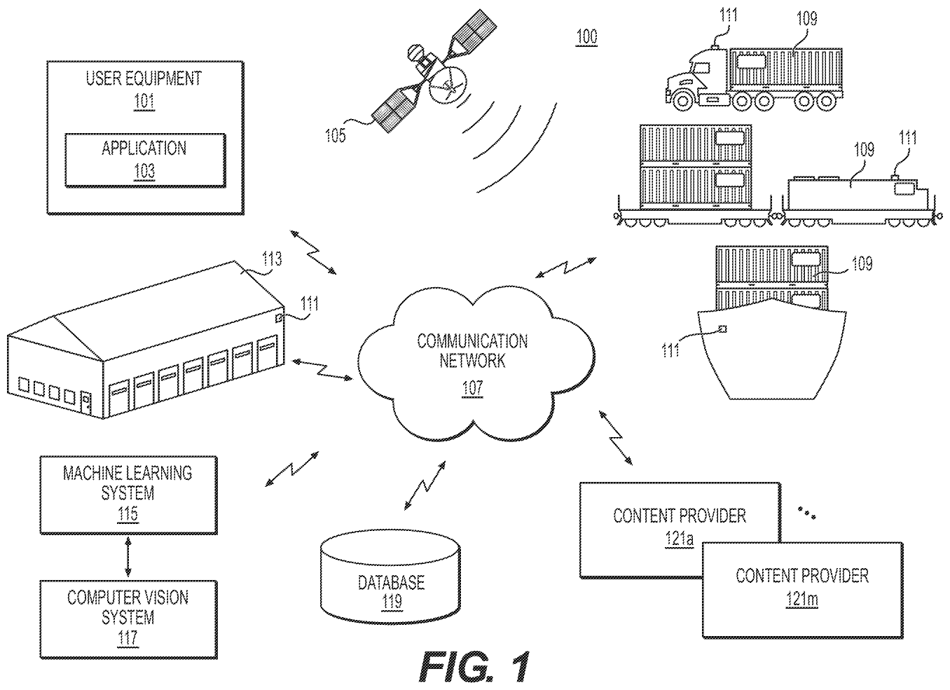

To address these technical challenges and problems, FIG. 1 of the present disclosure describes an exemplary system 100 configured to track, in real-time, inventory items associated with a warehouse system and/or to perform surveillance, in real-time, of the warehouse facility, for example, using machine learning system 115 and/or computer vision system 117. As shown in FIG. 1, system 100 may provide machine learning system 115 and computer vision system 117 in communication with one or more databases 119, content providers 121a-121m, warehouse facility 113, sensors 111, container vehicles 109, and/or user equipment 101 via any combination of communication network 107.

The embodiments of the present disclosure take advantage of modern technology infrastructure by implementing real-time data to automate the management of a warehouse. In one example embodiment, virtual technologies may be utilized to generate a digital copy of a warehouse system to monitor material flows in real-time, perform surveillance in real-time, and enable remote service. For example, digital devices, such as radio-frequency identification (RFID), sensors, scanners, and intelligent machines may generate data used to transform a static virtual warehouse model into a real-time 3D model that shows the occurrence of any event at any location in the warehouse in real-time. In another embodiment, system 100 may determine, in real-time, inventory status from one or more sensors. System 100 may also rely on automated and accurate mapping of goods stored inside the warehouse or arriving in the warehouse. Unlike manual procedures where specific asset locations are often incorrect or unknown, real-time location systems allow system 100 to know the precise location of the asset.

Referring again to FIG. 1, by way of example, user equipment 101 is any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that user equipment 101 can support any type of interface to the user (such as “wearable” circuitry, etc.). In one embodiment, user equipment 101 may be associated with or be a component of vehicle 109 and/or warehouse facility 113.

In one embodiment, user equipment 101, vehicle 109, and/or warehouse facility 113 may execute a software application 103 to capture image data, video data, or other observation data, according to the embodiments described herein. By way of example, application 103 may also be any type of application that is executable on user equipment 101, vehicle 109, and/or warehouse facility 113, such as camera/imaging application, content provisioning services, artificial intelligence (Al) applications, surveillance applications, location-based service applications, media player applications, networking applications, calendar applications, mapping applications, accounting-related applications, and the like. In one embodiment, application 103 may act as a client for the machine learning system 115 and/or computer vision system 117 and perform one or more functions associated with automated warehouse management.

In one embodiment, the communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, vehicle 109 may include any vehicle which could contain freight or cargo, e.g., trucks, truck-trailers, railway cars, intermodal vehicles, and movable containers transported by ship, aircraft, truck, and rail. In another embodiment, vehicle 109 may include regular vehicles, autonomous vehicles, or semi-autonomous vehicles. For example, vehicles 109 may carry intermodal containers, e.g., large standardized shipping containers that are designed and built for intermodal freight transport. These intermodal containers may be used across different modes of transport without unloading and reloading the cargo therein.

In one embodiment, user equipment 101, vehicle 109, and/or warehouse facility 113 are configured with various sensors 111 for generating or collecting environmental image data, e.g., for processing by the machine learning system 115 and/or computer vision system 117. In one example embodiment, sensors 111 include a camera/imaging sensor for gathering image data, e.g., the camera sensors may automatically capture ground control point imagery etc., for analysis.

In one example embodiment, applicable camera/imaging sensors include fixed cameras, movable cameras, zoom cameras, focusable cameras, wide-field cameras, infrared cameras, or other specialty cameras to aid in product identification or image construction, reduce power consumption and motion blur, and relax the requirement of positioning the cameras at a set distance. Such camera/imaging sensor may be positioned in a fixed or movable manner based upon the inventory information being sought, e.g., an image of the entire warehouse or images of smaller regions of the warehouse. The camera/imaging sensor may be instructed by machine learning system 115 to obtain images at various locations at various times. In one example embodiment, the camera/imaging sensor may obtain images in real-time, per demand, or according to a set schedule. In another example embodiment, machine learning system 115 may cause the camera/imaging sensor to obtain images in response to activities detected in a particular area. Such activities may be detected by identifying changes in an image or using motion sensors. In this manner, database 119 can be constantly updated without obtaining images throughout the warehouse. In one embodiment, the camera/imaging sensor may include signal processing capabilities that allow it to send only changes in the image relative to a previously obtained image.

In another embodiment, sensors 111 may also include a network detection sensor for detecting wireless signals or receivers for different short-range communications (e.g., Bluetooth, Wi-Fi, Li-Fi, near field communication (NFC), etc.), ultrasonic sensors that implement sound waves to detect objects, a magnetometer to detect objects by measuring changes in the ambient magnetic field, radar sensors, optical sensors, x-ray sensors, temporal information sensors, light sensors, audio sensors for gathering audio data, fuel sensor for determining fuel types and accurate measurements of fuel level in tanks of vehicle 109, and the like. In one scenario, sensors 111 may also detect weather data, traffic information, or a combination thereof. In one embodiment, sensors 111 may include acoustic sensors that use sound waves or electromagnetic fields to determine engine type, class type, and fuel type associated with vehicles 109. In a further embodiment, sensors 111 may also include a global positioning sensor for gathering location data (e.g., GPS). In one example embodiment, user equipment 101 and/or vehicle 109 may include GPS or other satellite-based receivers to obtain geographic coordinates from satellites 105 for determining current location and time. Further, the location can be determined by visual odometry, triangulation systems such as A-GPS, Cell of Origin, or other location extrapolation technologies. In one embodiment, the sensed data represent sensor data associated with a geographic location or coordinates at which the sensor data was collected.

In one embodiment, warehouse facility 113 may optimize operational processes of warehouses, yards, trucking companies, port terminals, shipping companies, railway companies, etc. Warehouse facility 113 may provide full visibility into real-time inventory levels and storage, surveillance, demand forecasting, and order fulfillment workflows. In another embodiment, warehouse facility 113 may include warehousing, loading, distribution, shipping, inventory management, order filling, order procurement or balancing against orders, etc. In one embodiment, warehouse facility 113 may implement electronic data interchange (EDI). EDI allows for electronic interchange of business information using a standardized format, thereby allowing warehouse facility 113 to electronically send information to warehouse facility of another warehouse in a standardized format.

In one embodiment, the machine learning system 115 and/or computer vision system 117 may be a platform with multiple interconnected components. The machine learning system 115 and/or computer vision system 117 may include multiple servers, intelligent networking devices, computing devices, components and corresponding software for automating the management of a warehouse. In addition, it is noted that the machine learning system 115 and/or computer vision system 117 may be a separate entity of the system 100, or included within the user equipment 101, vehicle 109, and/or warehouse facility 113.

In one embodiment, machine learning system 115 may implement supervised and/or unsupervised learning. In one instance, a supervised learning algorithm takes a known set of input data and known responses to the data (output) and trains a model to generate reasonable predictions for the response to new data. In one instance, unsupervised learning finds hidden patterns or intrinsic structures in data and draws inferences from datasets consisting of input data without labeled responses. In one embodiment, machine learning system 115 may mark or label a large set of training images. By way of example, such imagery or image data can be obtained from different sources such as but not limited to satellite 105, vehicle 109, sensors 111, drones, and/or other aerial vehicles. Labeling, for instance, includes identifying, e.g., using a human labeler, the pixel locations within each image. System 100 can then use the labeled training images to train the machine learning system 115 to predict pixel locations or data indicating the pixel locations in the input image data. In one embodiment, to facilitate and/or monitor the goods and services related to warehouse facility 113, system 100 can designate ground control points, i.e., identifiable points on the Earth's surface that have a precise location (e.g., in the form of <Latitude, Longitude, Elevation>) associated with them. In one embodiment, ground control points find additional applications in camera pose refinement of satellite, aerial, and ground imagery, and hence provide for increased position fidelity for location data determined from these data sources. In turn, any derived products like building polygons, map objects made from these data sources inherit the accuracy. In addition, ground control points can also serve the localization of the vehicles where they can be geocoded localization objects that vehicle can measure its position. In one embodiment, machine learning system 115 may implement an optical character recognition (OCR) technology for mechanical or electronic conversion of images of typed, handwritten, or printed text into machine-encoded text. Machine learning system 115 may automate data extraction from typed, handwritten, or printed text from an image file and then convert the text into a machine-readable form to be used for data processing.

In one embodiment, computer vision system 117 may perform segmentation of image/video content into multiple regions or pieces to be examined separately. In another embodiment, computer vision system 117 may identify specific objects in an image/video content and classify the object to a defined category. In a further embodiment, computer vision system 117 may seamlessly monitor, track, and account for objects within an observed space. In another embodiment, computer vision system 117 may be configured to use machine learning to detect objects or features depicted in images that can be used as ground control points. For example, computer vision system 117 can detect ground control points in input images and generate ground control point data (e.g., location data) and associated prediction confidence values/uncertainties, according to the various embodiments described herein. In one embodiment, computer vision system 117 may implement a non-intrusive asset mapping and tracking, e.g., radio, ultrasonic, any type of scanning technology, to perform damage classification and analysis of inventory, e.g., containers. In one instance, non-intrusive is a system that does not use any technology that needs to be placed on the inventory, e.g., RFID tags, codes, or markings. In one embodiment, the RFID tags may contain electronically stored information, e.g., passive tags may collect energy from a nearby RFID reader's interrogating radio waves, and active tags may have a local power source (such as a battery) and may operate hundreds of meters from the RFID reader.

In one embodiment, database 119 may be any type of database, such as relational, hierarchical, object-oriented, and/or the like, wherein data are organized in any suitable manner, including as data tables or lookup tables. In one embodiment, database 119 may store and manage multiple types of information that can provide means for aiding in the content provisioning and sharing process. In an embodiment, database 119 may include a machine-learning based training database with pre-defined mapping defining a relationship between various input parameters and output parameters based on various statistical methods. In an embodiment, the training database may include machine-learning algorithms to learn mappings between input parameters related to warehouse facilities such as but not limited to inventory information, real-time status information of the inventory, real-time surveillance information, etc. In an embodiment, the training database may include a dataset that may include data collections that are not subject-specific. Exemplary datasets include environmental information, geographic data, climate data, meteorological data, market data, encyclopedias, business information, and the like. In an embodiment, the training database is routinely updated and/or supplemented based on machine learning methods.

In one embodiment, content providers 121a-121m (collectively referred to as content providers 121) may provide content or data to machine learning system 115, database 119, computer vision system 117, user equipment 101, the vehicle 109, and/or an application 103 executing on user equipment 101. The content provided may be any type of content, such as image content, video content, map content, textual content, audio content, etc. In one embodiment, the content providers 121 may provide content that may aid in the detecting and classifying features in image and/or video data. In one embodiment, the content providers 121 may also store content associated with the database 119, machine learning system 115, computer vision system 117, user equipment 101, and/or vehicle 109. In another embodiment, the content providers 121 may manage access to a central repository of data, and offer a consistent, standard interface to data, such as a repository of database 119.

By way of example, the machine learning system 115, computer vision system 117, warehouse facility 113, user equipment 101, vehicle 109, and/or content providers 121 communicate with each other and other components of the system 100 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information.

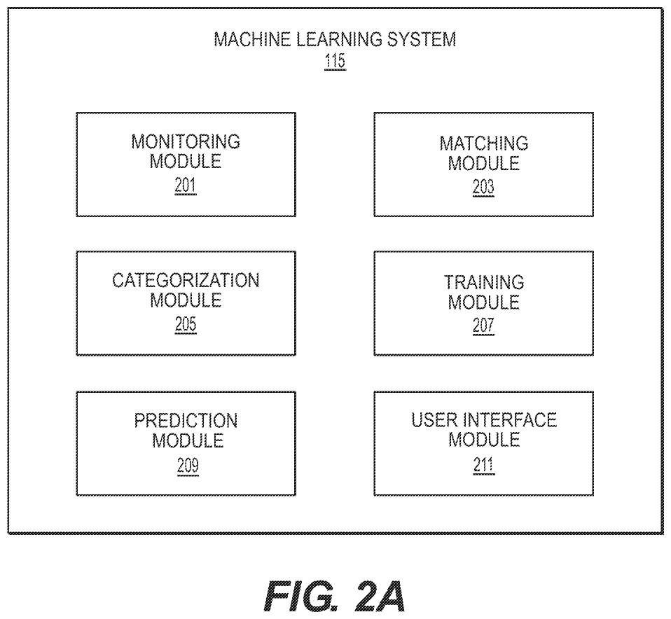

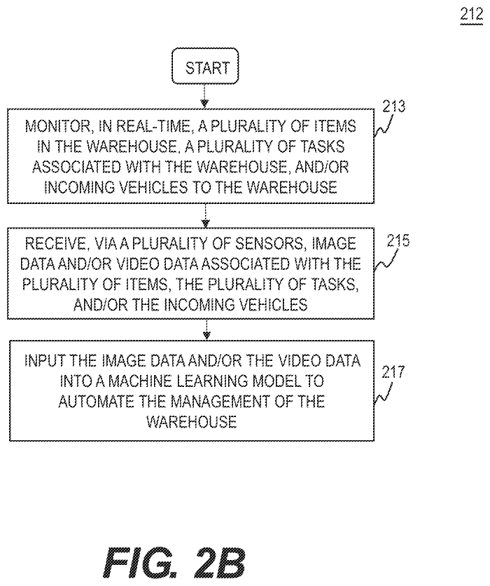

FIG. 2A is a diagram of the components of machine learning system 115, according to one example embodiment. By way of example, machine learning system 115 includes one or more components for automating the management of a warehouse facility. It is contemplated that the functions of these components may be combined in one or more components or performed by other components of equivalent functionality. In one embodiment, machine learning system 115 comprises monitoring module 201, matching module 203, categorization module 205, training module 207, prediction module 209, and user interface module 211, or any combination thereof.

In one embodiment, monitoring module 201 may monitor, in real-time, the warehouse environment. In one instance, the warehouse environment includes real-time inventory information, estimated future inventory information, and historical inventory information. In one example embodiment, monitoring module 201 may monitor misplaced items within the warehouse environment, and may provide feedback associated with the misplaced items based on detected events, e.g., suggest correct locations for misplaced items. In another example embodiment, monitoring module 201 may monitor services that have not been completed per schedule and may recommend prioritization of such services to avoid further delays. In another embodiment, monitoring module 201 may monitor, in real-time, location information, operating schedule information, or a combination thereof of vehicles 109 and/or user equipment 101 associated with the driver of vehicles 109. In another example embodiment, monitoring module 201 may provide probe data, in real-time, of vehicles 109 carrying cargos from or to warehouse facility 113.

In one embodiment, matching module 203 retrieves a plurality of content from sensor 111. Thereafter, matching module 203 compares and evaluates the retrieved content with the corresponding data record, e.g., data stored in database 119, content provider 121, or a combination thereof, to determine a degree of similarity. In one embodiment, the matching module 203 may implement an image matching process to compare and evaluate content for similarity. In accordance with an embodiment, the image matching process may correspond to a grid point matching. In another embodiment, matching module 203 may implement an automatic video post-processing method that extracts metadata from sequences of video frames to determine similarity. In one example embodiment, video frames are a sequence of still images that are captured (or displayed) at a different time. The matching module 203 may analyze the content by comparing and evaluating it with the corresponding data record to determine a match. In one embodiment, matching module 203 may utilize one or more algorithms, e.g., machine learning algorithms, to determine a match for the content based, at least in part, on the comparison. Based on this matching, categorization module 205 is triggered to cluster similar content in the same category.

In one embodiment, categorization module 205 may analyze the images or sequences of video, e.g., via feature extraction, to determine characteristic parameter(s) of the images or sequences of video for categorization. In one example embodiment, categorization module 205 may categorize an image or sequences of video based on trained attribute detection, e.g., analyze the image or sequences of video based on trained classifier algorithms and then associate attributes with the image or sequences of video. In another example embodiment, categorization module 205 may track multiple objects detected in the current image or sequences of video to associate objects detected in past images or sequences of video. In accordance with various embodiments, categorization module 205 may perform region segmentation of the image or sequences of video to identify one or more attributes. For example, categorization module 205 may cut out the image portion, such as by identifying the image portion boundary and removing extraneous data. In a further example embodiment, when a large number of objects are captured in a current frame and sufficient resources may not be available to track all of the objects, the categorization module 205 may determine an order for tracking in which the most important objects are tracked first and noisy observations last, thereby reducing the possibility of erroneously categorizing unknown observations.

In one embodiment, machine learning system 115 may implement training module 207 to train the other modules, e.g., train matching module 203 to match images or sequences of video frames. In one example embodiment, training module 207 may prepare test data for the training process. The training module 207 may receive images or sequences of video frames, and labels for the images or sequences of video frames to indicate categories or attribute information. The training module 207 may select images or sequences of video frames as representative samples of each category or unique instance of an attribute, category, or the like. In another embodiment, the training module 207 can continuously provide and/or update machine learning system 115 during training using, for instance, supervised deep convolution network or equivalents.

In one embodiment, the prediction module 209 may process the input image data, via computer vision system 117 or equivalent, to recognize pixels corresponding to the features in image data. The recognition process can identify the pixel locations in each image corresponding to the features. In one example embodiment, when input image data include multiple images of the same feature, prediction module 209 can create pixel correspondences of the feature across the multiple images. In one embodiment, prediction module 209 creates an input vector, input matrix, or equivalent comprising the pixel locations/pixel correspondences extracted above along with any other features/attributes used to train machine learning system 115. By way of example, these other features/attributes can include but is not limited to image itself, derived attributes of the images (e.g., resolution, exposure, camera position, focal length, camera type, etc.), the corresponding data sources (e.g., satellite, airplane, drone, etc.), contextual data at the time of image capture (e.g., time, weather, etc.), and/or the like. In one embodiment, creating the input vector includes converting the extracted features to a common format, normalizing values, removing outliers, and/or any other known pre-processing step to reduce data anomalies in the input data.

In one embodiment, user interface module 211 enables a presentation of a graphical user interface (GUI) in a user equipment 101. User interface module 211 employs various application programming interfaces (APIs) or other function calls corresponding to the applications on the user equipment 101, thus enabling the display of graphics primitives such as icons, menus, buttons, data entry fields, etc., for generating the user interface elements. In another embodiment, user interface module 211 may cause interfacing of the guidance information with one or more users to include, at least in part, one or more annotations, audio instructions, video instructions, or a combination thereof. In a further example embodiment, user interface module 211 may be configured to operate in connection with augmented reality (AR) processing techniques, wherein various applications, graphic elements, and features may interact. In another example embodiment, user interface module 211 may comprise a variety of interfaces, for example, interfaces for data input and output devices, referred to as I/O devices, storage devices, and the like.

The above presented modules and components of machine learning system 115 may be implemented in hardware, firmware, software, or a combination thereof. Though depicted as a separate entity in FIG. 1, it is contemplated that machine learning system 115 may be implemented for direct operation by respective user equipment 101. As such, machine learning system 115 may generate direct signal inputs by way of the operating system of the user equipment 101. In another embodiment, one or more of the modules 201-211 may be implemented for operation by respective UEs, as machine learning system 115, or combination thereof. The various executions presented herein contemplate any and all arrangements and models.

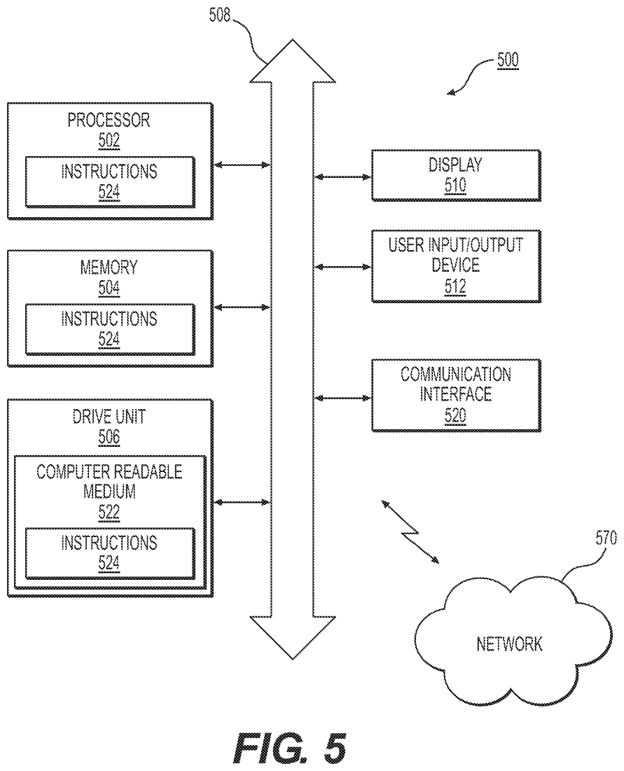

FIG. 2B is a flowchart of a process for automating the management of a warehouse, according to one example embodiment. In various embodiments, machine learning system 115 and/or any of modules 201-211 may perform one or more portions of process 212 and may be implemented in, for instance, a chip set including a processor and a memory as shown in FIG. 5. As such, machine learning system 115 and/or any of modules 201-211 may provide means for accomplishing various parts of process 212, as well as means for accomplishing embodiments of other processes described herein in conjunction with other components of system 100. Although process 212 is illustrated and described as a sequence of steps, it is contemplated that various embodiments of process 212 may be performed in any order or combination and need not include all of the illustrated steps.

In step 213, machine learning system 115 may monitor, in real-time or near real-time, a plurality of items in the warehouse, a plurality of tasks associated with the warehouse, and/or incoming vehicles to the warehouse.

In step 215, machine learning system 115 may receive, via a plurality of sensors, e.g., sensors 111, image data and/or video data associated with the plurality of items, the plurality of tasks, and/or the incoming vehicles. In one embodiment, the image data and/or the video data may indicate a change in position of at least one of the plurality of items, at least one incomplete task from the plurality of tasks, and/or a change in location of at least one of the incoming vehicles. In one embodiment, the plurality of sensors may collect the image data and/or the video data in real-time, per demand, according to a set schedule, in response to one or more activities detected in a particular area of the warehouse, or a combination thereof. In one embodiment, machine learning system 115 may process and segment the image data and/or the video data into a plurality of regions. Machine learning system 115 may identify objects in the segmented plurality of regions to classify the objects to pre-defined categories.

In step 217, machine learning system 115 may automate the management of the warehouse based, at least in part, on the received image data and/or the video data. In one embodiment, the machine learning model may utilize the predictions for the inputted data for retraining to generate predictions for newly inputted data and improve accuracy of error handling. In one embodiment, machine learning system 115 is trained, via training module 207 utilizing supervised learning that applies a set of known input data and known responses to the input data, to generate predictions for new data. In one embodiment, machine learning system 115 may detect, in real-time, probe data of the incoming vehicles to predict the time of arrival at the warehouse. Machine learning system 115 may retrieve data associated with the incoming vehicles from a database, e.g., database 119. The retrieved data from the database may include license plate data, vehicle attributes, and/or identification information of drivers of the incoming vehicles. Machine learning system 115 may compare the image data and/or the video data associated with the incoming vehicles with the retrieved data to determine a match for authenticating the incoming vehicles to enter the warehouse. Machine learning system 115 may generate one or more reports on the incoming vehicles per schedule, on-demand, or periodically. The reports may include the total number of vehicles that visited the warehouse, the date and time of arrival or departure of the incoming vehicles, chassis information, load information, vehicle type, and/or fuel type information.

In one embodiment, machine learning system 115 via monitoring module 201 may determine, in real-time or near real-time, available spaces in warehouse facility 113. In another embodiment, machine learning system 115 may automatically calculate usage of warehouse facility 113 on a daily basis to determine the total available spaces and/or the number of spaces assigned (reserved) to the users, e.g., customers. The available spaces may include storage spaces for various types of goods and/or parking spaces for various types of vehicles, e.g., trucks, containers, or trailers. Machine learning system 115 may generate notifications pertaining to the available spaces in UE 101 associated with the users and/or broadcast the available spaces on a website. The notifications and/or broadcast may include information pertaining to the available spaces, e.g., dimension information and/or cost information for renting the available space (e.g., hourly fee, daily fee, monthly fee, yearly fee, etc.). The users may utilize their respective UE 101 or access the website to reserve the available spaces per their requirements and make the payments in advance. During the reservation of the available parking spaces, a user may enter goods specification (e.g., dimension information), vehicle specifications (e.g., dimension information, vehicle type such as an electric vehicle), temporal information (e.g., duration of parking), and/or location information (e.g., destination, preferred location to store or park). Machine learning system 115 may generate a recommendation of a parking space from the available parking spaces that match the specifications, temporal information, and/or location information.

In one embodiment, computer vision system 117 may detect, in real-time or near real-time, the goods and/or vehicles entering the premises of warehouse facility 113. Computer vision system 117 may visually validate the reservation and may verify the condition of the goods and/or vehicles, e.g., check for wear/tear or damages. Computer vision system 117 may monitor the time of the entry of goods and/or vehicles into warehouse facility 113, the duration of storage and/or parking, and the time of exit from warehouse facility 113. Computer vision system 117 may transmit the monitored information to machine learning system 115, and machine learning system 115 may generate an invoice for the total duration of storage and/or parking in warehouse facility 113. The invoice may be presented in a user interface of UE 101 and/or the website associated with the service provider, and the user may pay for the services via online banking, e.g., electronically transfer the money from their bank account to the account of the service provider. The generation and presentation of the invoice may be customized per requirement, e.g., daily, weekly, or bi-weekly basis, and may be integrated with various accounting-related software applications.

In one embodiment, machine learning system 115 may generate a presentation in the user interface of UE 101 associated with the service providers on the real-time status of the number of rented spaces in warehouse facility 113 and the total income the rented spaces are generating. In one example embodiment, the service providers may interact with the user interface elements in their respective UE 101 to view the number of spaces occupied by any specified users, e.g., tenants, at a point in time and set up automated reports directed to the specified users that detail the quantity of assets stored in warehouse facility 113 and the associated balance for renting the space.

In one embodiment, machine learning system 115 may determine whether one or more users have exceeded the duration of their stay in the rented space. In one example embodiment, machine learning system 115 may notify the users in their respective UE 101 that they have overstayed and are subject to penalty fees, e.g., on an hourly basis or a daily basis. In another example embodiment, machine learning system 115 may generate alerts in the UE 101 of the users that they have exceeded their duration and have to leave the rented space because of bookings by other users to ensure the spaces are available per their reserved timings.

In one embodiment, machine learning system 115 may determine the operating condition of the incoming vehicles based, at least in part, on the image data, the video data, and/or other data associated with the incoming vehicles. The other data may indicate usage statistics, maintenance data, and/or wear and tear on components of the incoming vehicle. Machine learning system 115 may generate a notification in user interfaces of devices associated with the drivers of the incoming vehicles. The notification may include a recommendation for maintenance of the incoming vehicles before performing the next assignment. In another embodiment, machine learning system 115 may generate at least one user interface in devices associated with the drivers of the incoming vehicles for verifying the drivers, wherein the drivers are requested login credentials. Machine learning system 115 may automatically assign parking spaces to the incoming vehicles based, at least in part, on task information, vehicle type, and/or dimension information. Machine learning system 115 may generate a navigation element in the user interface of the devices to navigate the drivers toward the assigned parking spaces in the warehouse.

In one embodiment, machine learning system 115 may determine inventory status based, at least in part, on the monitoring of the plurality of items in the warehouse. The inventory status may indicate the total items in the warehouse, location of each of the plurality of items in the warehouse, and capacity of the warehouse to store additional items. In another embodiment, machine learning system 115 may generate a recommendation for correctly positioning one or more misplaced items in the warehouse based, at least in part, on detecting one or more items are incorrectly placed in the warehouse. In another embodiment, machine learning system 115 may generate a recommendation for prioritizing one or more incomplete tasks to prevent additional delays based, at least in part, upon determining the one or more tasks have not been completed per schedule.

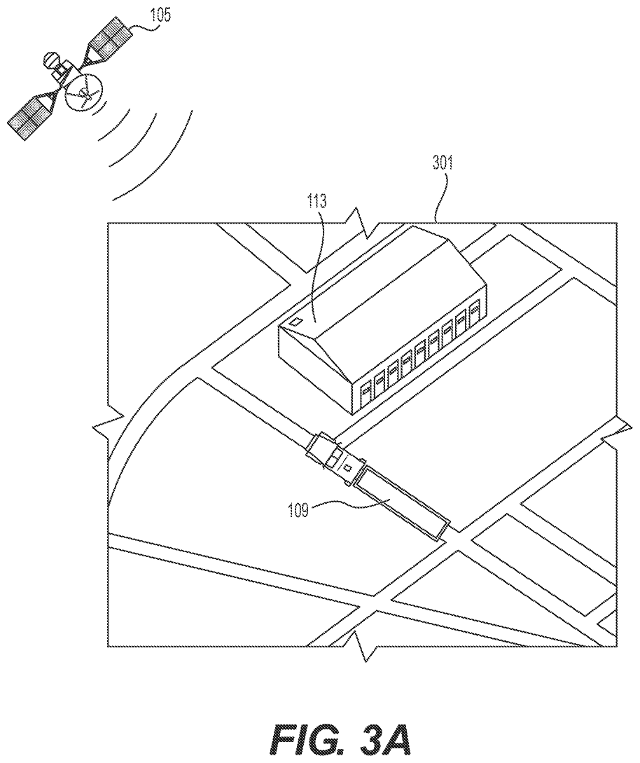

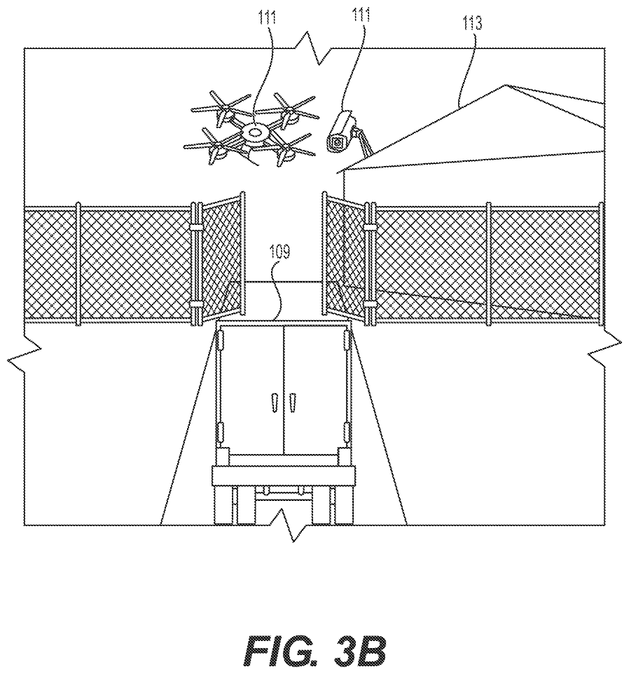

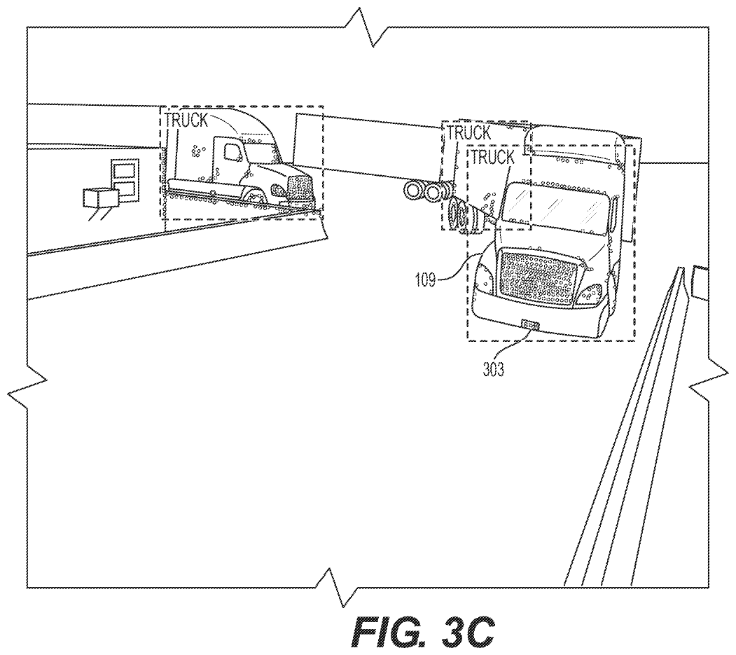

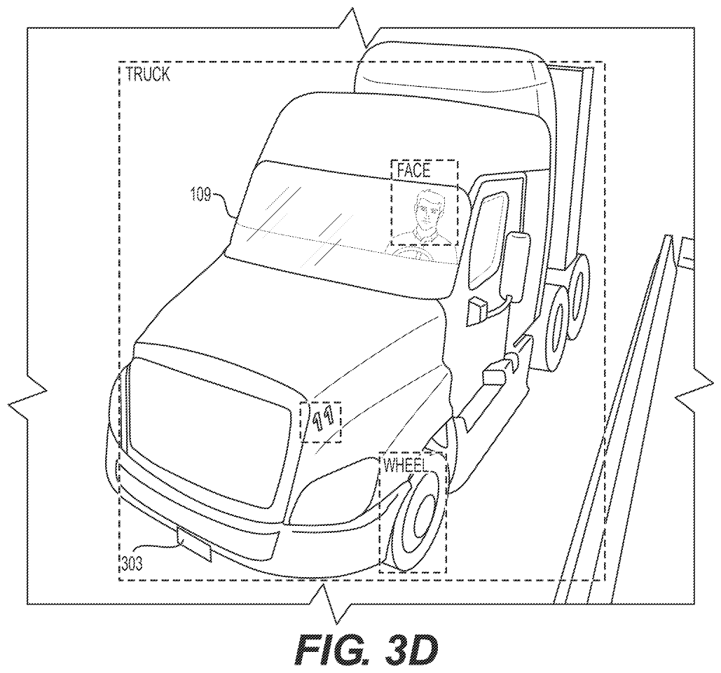

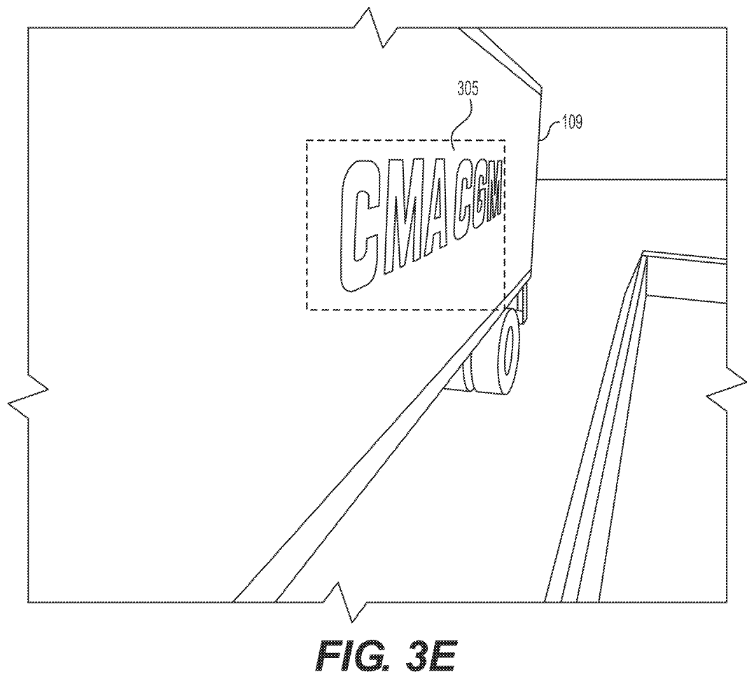

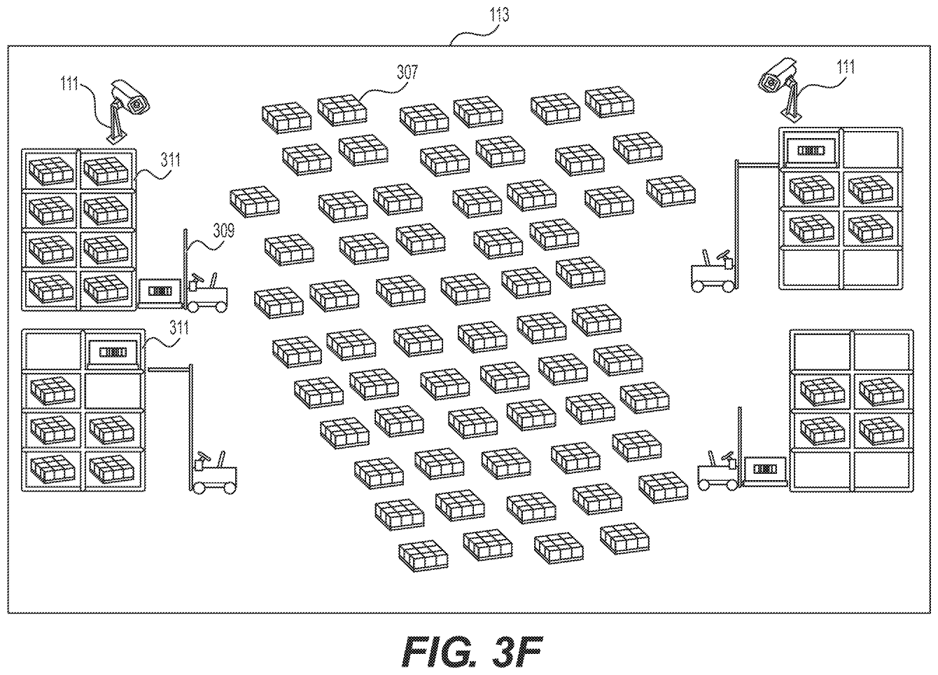

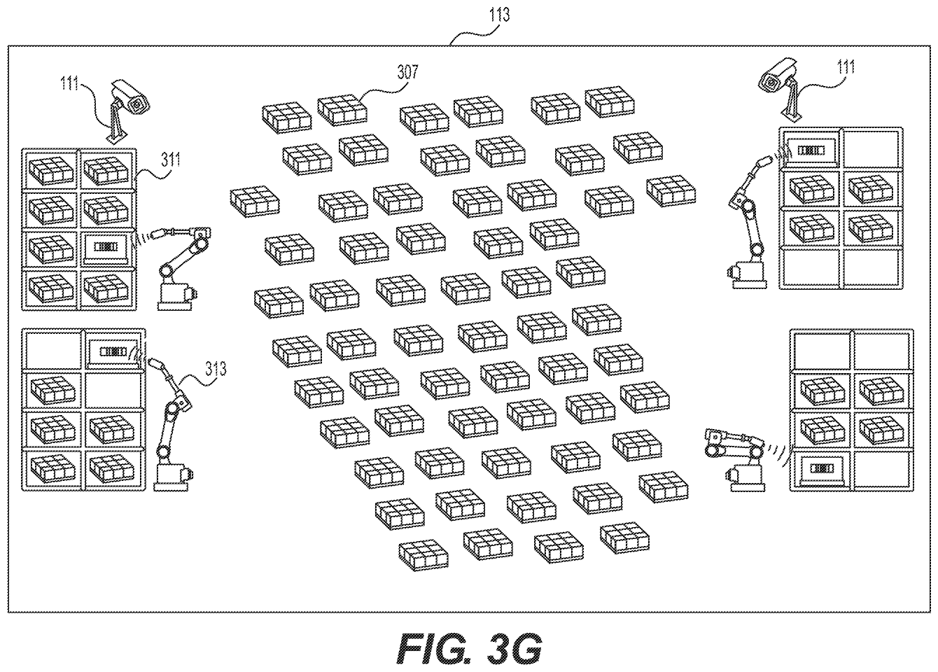

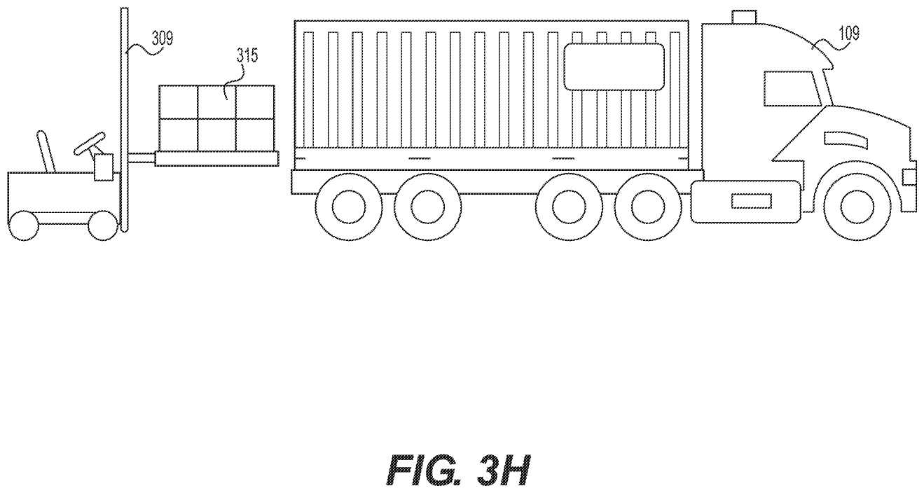

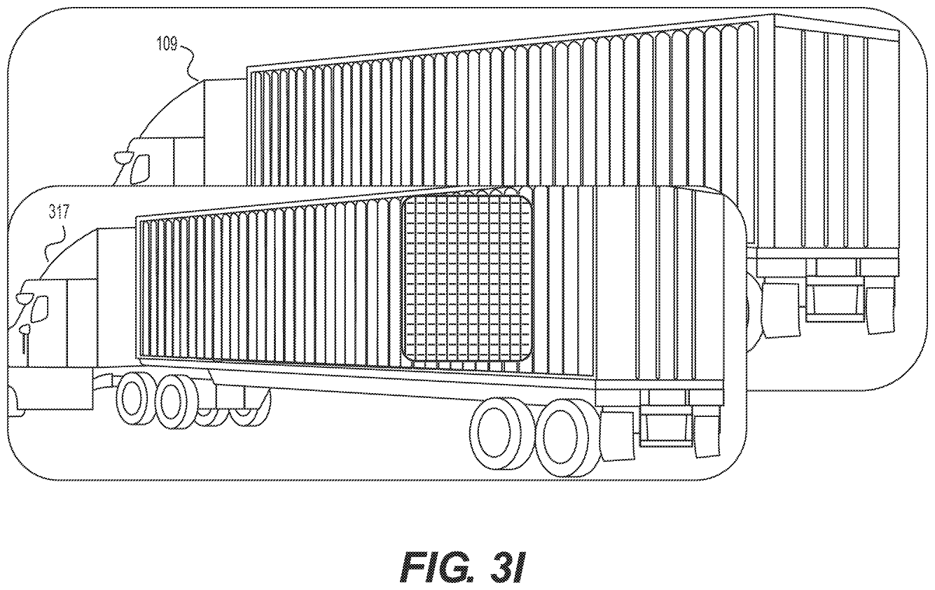

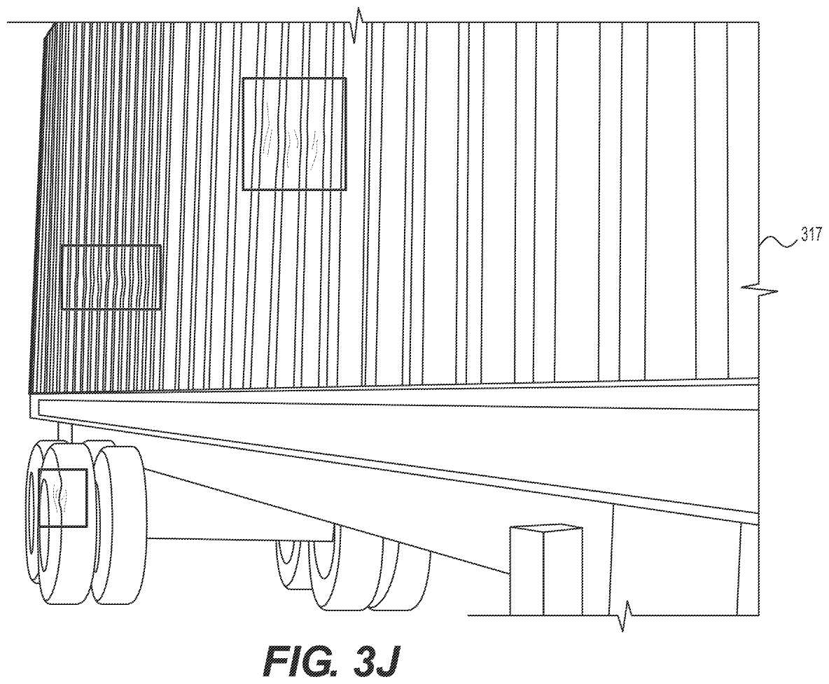

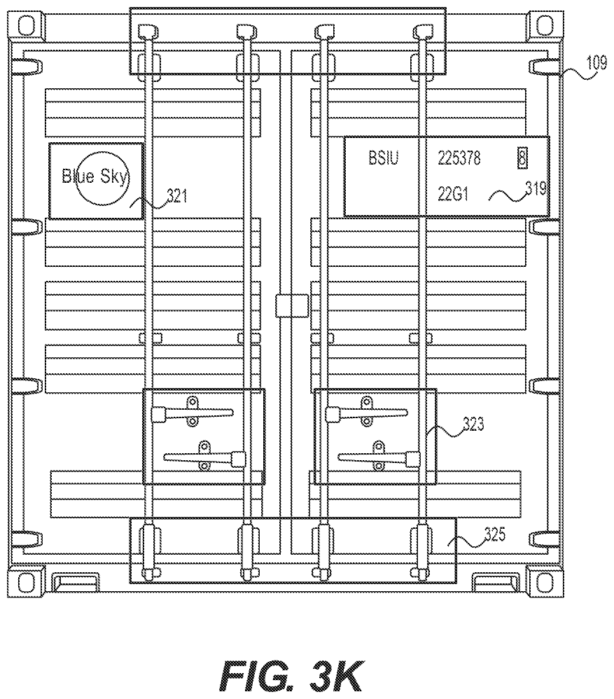

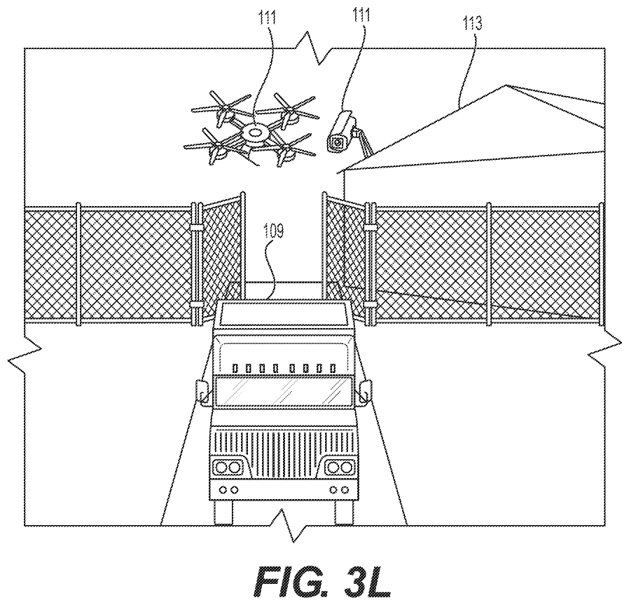

FIG. 3A illustrates top-down imagery 301 that depicts warehouse facility 113 and its surroundings, according to one embodiment. Top-down imagery refers to image data or video data that are captured, via satellite 105 or other aerial sensors, from an overhead or aerial perspective so that the camera is pointed down towards warehouse facility 113. The axis of the pointing direction of the camera can vary from a direct overhead, e.g., perpendicular angle, or to an oblique angle from either side. In one embodiment, the camera pose or position data can be provided with the imagery and then refined to greater accuracy using ground control points. Other camera attributes, e.g., focal length, camera type, etc., and/or environmental attributes, e.g., weather, time of day, etc., can be provided with the imagery. For example, the resolution of top imagery of different satellites or other aerial sources can vary depending on the kind of camera sensors used. These different sensors then produce images with different resolutions. This variance, in turn, can lead to uncertainty or error. Accordingly, the machine learning system 115 may be further trained to calculate an uncertainty associated with the predicted location based on a characteristic of said each of the plurality of images, a respective source of said each of the plurality of images, or a combination.

In one example embodiment, machine learning system 115 predicts delivery of products from vehicle 109. The warehouse facility 113 may receive product information, e.g., product types, product size, product cost, etc., and vehicle information, e.g., vehicle model, vehicle color, dimension information, license plate information, driver information, etc. from third-party service providers. Thereafter, warehouse facility 113 may transmit this information, in real-time, to machine learning system 115 and computer vision system 117. In one embodiment, the machine learning system 115 and computer vision system 117 may instruct satellite 105 or other aerial sensors to capture, in real-time, the progression of vehicle 109 towards warehouse facility 113. In another embodiment, the machine learning system 115 and computer vision system 117 may directly communicate with sensors 111 of vehicle 109 to receive, in real-time, location information of vehicle 109.

FIG. 3B depicts a ground-level view of sensor 111 capturing vehicle 109 approaching the vicinity of warehouse facility 113, according to one embodiment. In one embodiment, machine learning system 115 and computer vision system 117 may automatically retrieve information associated with vehicle 109, e.g., vehicle model, vehicle color, dimension information, license plate information, driver information, etc., as vehicle 109 approaches the predetermined proximity threshold to warehouse facility 113. For example, as vehicle 109 approaches the entrance of warehouse facility 113, location sensor 111 detects its presence and provides a signal indicative thereof to machine learning system 115 and computer vision system 117. In response to generating this signal, machine learning system 115 and computer vision system 117 may instruct image/camera sensors 111, e.g., a high-resolution camera, to capture images/videos of vehicle 109. The machine learning system 115 and computer vision system 117 may process the captured images/videos to identify the license tag's unique letter and/or number (as shown in FIG. 3C). This can be achieved by any of a variety of well-known optical character recognition schemes. For example, an electronic image, e.g., a digital American Standard Code for Information Interchange (ASCII) character string, of the identifying indicia on license tag 303 can be formed. Then, machine learning system 115 and computer vision system 117 may access database 119 to find information associated with license tag 303, e.g., vehicle model, vehicle make, vehicle owner information, etc. Subsequently, vehicle 109 is allowed entrance upon determining a match between the detected information and the stored information for vehicle 109. Since all of the states do not require a license tag on the front of vehicles, but all states do require a license tag on the rear of vehicles, sensors 111 are positioned in a manner to conveniently capture an image of the back of vehicle 109.

In another embodiment, machine learning system 115 and computer vision system 117 may implement a number of processor technologies known in the art such as a deep learning model, a recurrent neural network (RNN), a convolutional neural network (CNN), a feed-forward neural network, or a Bayesian model to classify vehicle 109. For example, CNN convolves learned features with input data, and uses 2D convolutional layers, making this architecture well suited to processing 2D data, such as images. CNN works by extracting features directly from images. The relevant features are not pre-trained; they are learned while the network trains on a collection of images. This automated feature extraction makes deep learning models highly accurate for computer vision tasks such as object classification. In one example embodiment, machine learning system 115 and computer vision system 117 may also classify vehicle 109 based upon audio data gathered from the sound made by a moving or stationary vehicle 109 with a running engine.

Once vehicle 109 enters the warehouse facility, system 100 may perform multiple authentications by continuously monitoring vehicle 109 to confirm other vehicular information. In one example embodiment, system 100 may implement a face recognition technology that analyzes images of the driver of vehicle 109 and may use biometrics to map facial features from the images with the information stored in the database 119 to confirm the identity of the driver (as depicted in FIG. 3D). In another example embodiment, system 100 may process the captured images of the vehicle to confirm other vehicular information, e.g., dimension information, color information, texts on the vehicle. For example, the height, width, and/or color of vehicle 109 may be compared with the information stored in database 119 to further validate the identification of vehicle 109.

In one embodiment, machine learning system 115 and computer vision system 117 may process other information detected on a vehicle. For example, in FIG. 3E, sensors 111 detect textual information 305, e.g., logos, emblems, symbols, etc., on vehicle 109. Machine learning system 115 and computer vision system 117 may process textual information 305 to associate the vehicles with third-party companies. In one instance, the third-party companies are enterprises that conduct regular business with warehouse facility 113 and have been authenticated by system 100. Such an additional verification step enhances security measures of system 100.

In one embodiment, machine learning system 115 and computer vision system 117 may activate different sensors based on location proximity information between vehicle 109 and warehouse facility 113. For example, satellite 105 or GPS sensors may be utilized for proximity beyond a threshold distance, and camera sensors may be utilized when the proximity is within the threshold distance.

FIG. 3F depicts a scenario wherein system 100 manages and monitors, in real-time, inventory 307 of warehouse facility 113, and then maintains an accurate record of the location and movement of inventory 307, according to one embodiment. In one embodiment, system 100 may employ automated machines 309 to organize packages once a shipment enters warehouse facility 113. For example, automated machines 309 may automatically stack and store packages; placement can be decided algorithmically, depending on the popularity of each product so that frequently purchased items are easily accessible and items that are bought infrequently are further away. Since an automated machine 309 is responsible for handling dangerous machinery and storing inventory in hard-to-reach places, it is less likely that an accident will occur. In one embodiment, automated machines 309 may scan and report shipment information, e.g., size, number, weight, and type, and maintain an accurate record of inventory 307.

As depicted in FIG. 3G, mobile robot 313 comprising a plurality of sensors is moved within an area of warehouse facility 113 to scan each item of inventory 307. Mobile robot 313 may transmit, in real-time, sensor information to machine learning system 115, and machine learning system 115 may update inventory information in database 119. In one example embodiment, each item of inventory 307 may comprise a sensor or a tag, e.g., radio frequency identification (RFID) tags. Mobile robot 313 may comprise an RFID reader that reads and writes information to the RFID tags. In another embodiment, warehouse facility 113 comprises smart shelves 311 that are equipped with weight sensors, proximity sensors, 3D cameras, microphones, RFID tags, near-field communication (NFC), electronic printed tags, LED sensors, optical sensors, IOT sensors, etc., to monitor the occupancy, vacancy, and/or capacity of the shelf. These smart shelves 311 are designed to automatically keep track of products on the shelf, e.g., when an item/product is picked from the shelf, smart shelves 311 may send a notification, in real-time, to user equipment 101, machine learning system 115, computer vision system 117, or a combination thereof. In such a manner, real-time inventory status is available without the errors and delays associated with manual level readings.

In FIG. 3H, one or more automated machines may load packages from the inventory to a vehicle, according to one embodiment. In one example embodiment, machine learning system 115 may receive a request for specific products from inventory 307. Thereafter, machine learning system 115 may instruct automated machines 309 to select the requested products from inventory 307, and then mobile robots 313 may safely pack the products. Subsequently, automated machines 309 may load packages 315 to vehicle 109. Once, the packages are loaded, automated machines 309 may alert machine learning system 115, and machine learning system 115 may update the inventory records in database 119.

In one embodiment, machine learning system 115 may receive image 317 of vehicle 109 from sensors 111 (as depicted in FIG. 31). In one example embodiment, machine learning system 115 may process received image 317 to identify various information about vehicle 109. In one instance, information about vehicle 109 may include vehicle make, vehicle model, vehicle year, tag information, dimension information, cargo information, capacity information, vehicle history, and the like. In another instance, information about vehicle 109 may include information on the driver and passengers of vehicle 109. In another embodiment, machine learning system 115 may process received image 317 to detect damages on vehicle 109, e.g., dings and dents, punctures, tire damages, tire pressure etc., (as depicted in FIG. 3J). The machine learning system 115 may generate an alert regarding the detected damages in user equipment 101 associated with the driver of vehicle 109. The machine learning system 115 may also store the images in database 119 for future reference. In a further example embodiment, machine learning system 115 may extract critical data from received images 317 (as shown in FIG. 3K). In one instance, machine learning system 115 may extract alphanumeric text 319 and logo 321, and then compare this extracted information with the stored information to authenticate vehicle 109. In another instance, machine learning system 115 may extract data on the locks, i.e., 323 and 325, to ensure the doors of vehicle 109 are securely locked for the safety of the cargos and the neighboring vehicles.

FIG. 3L depicts vehicle 109 leaving warehouse facility 113 after completing the service of delivering or picking a shipment, according to one embodiment. System 100 may record the date and time of departure of vehicle 109 in database 119.

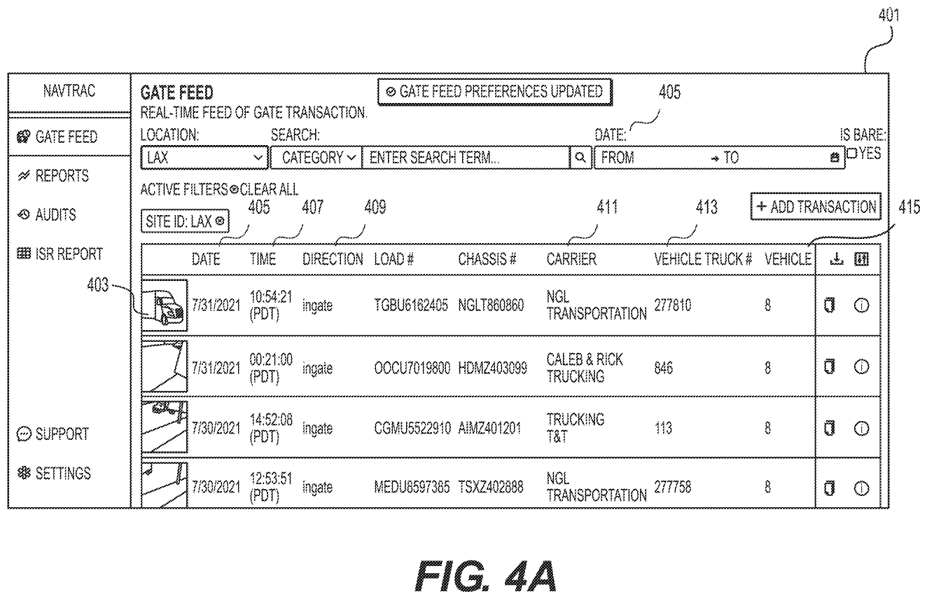

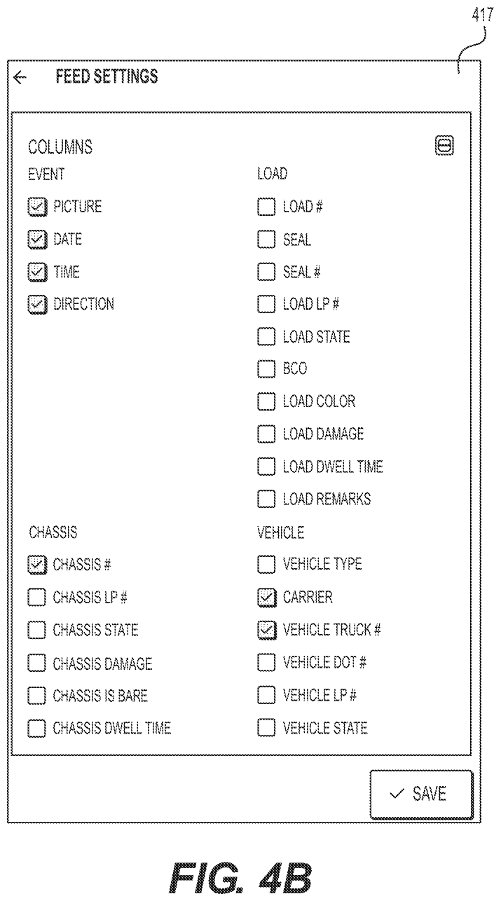

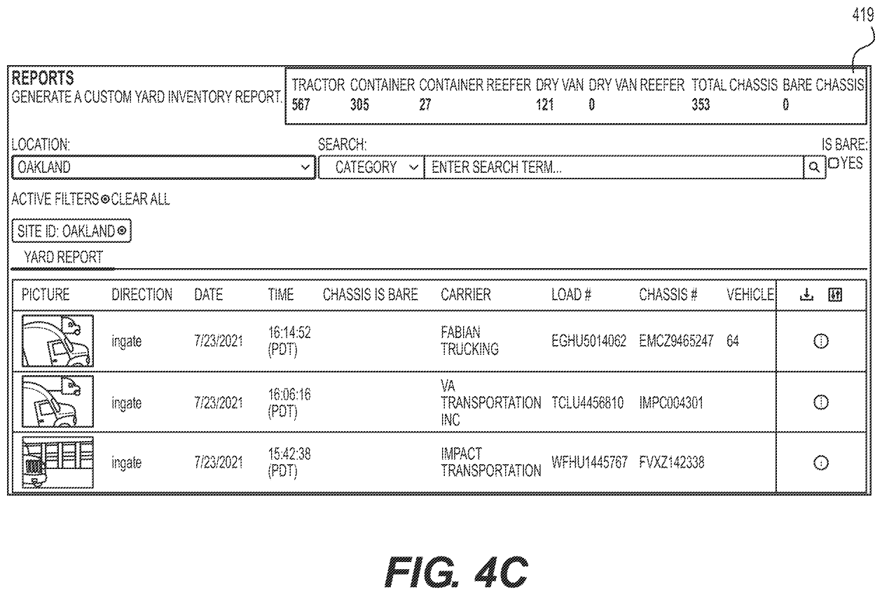

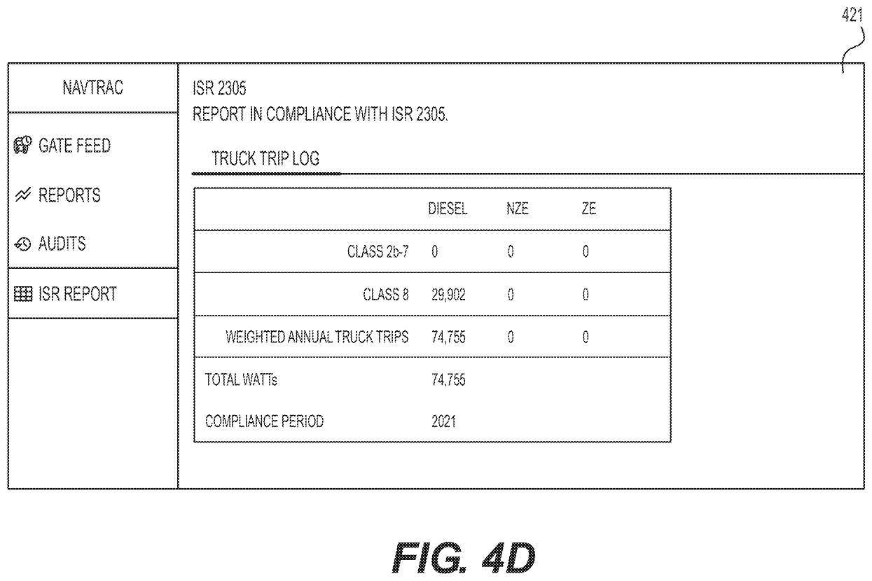

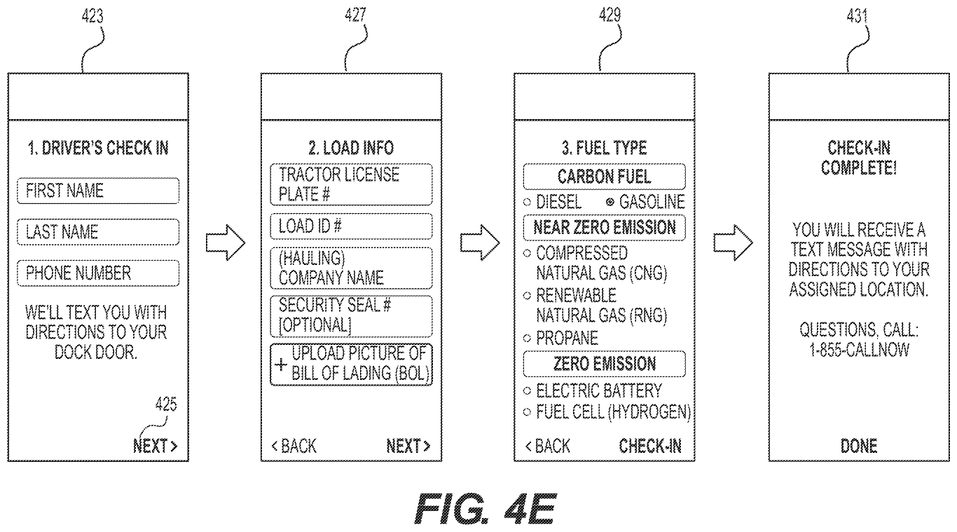

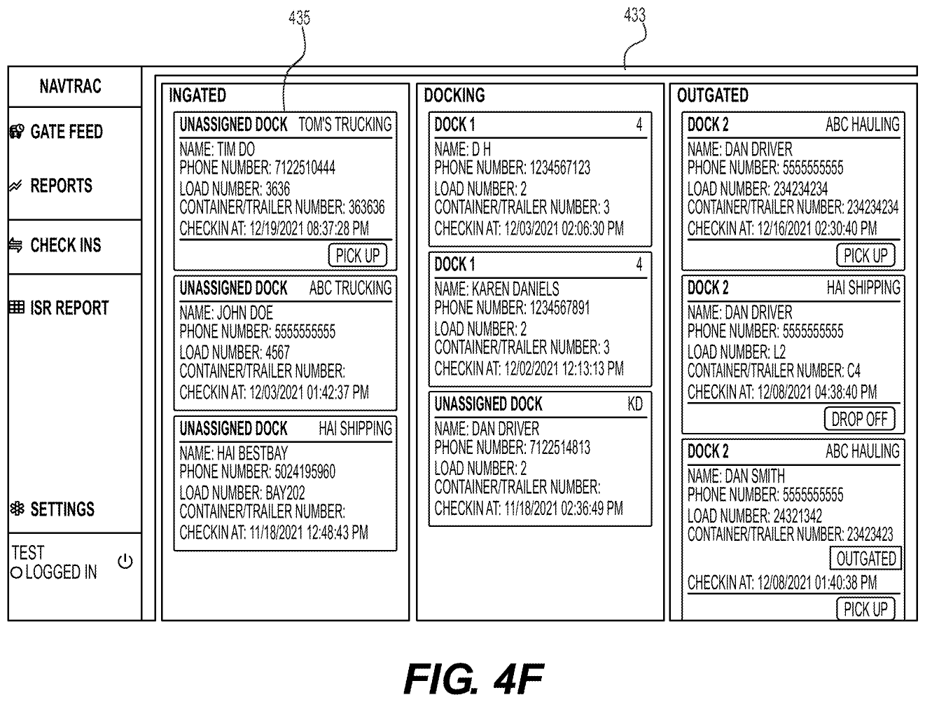

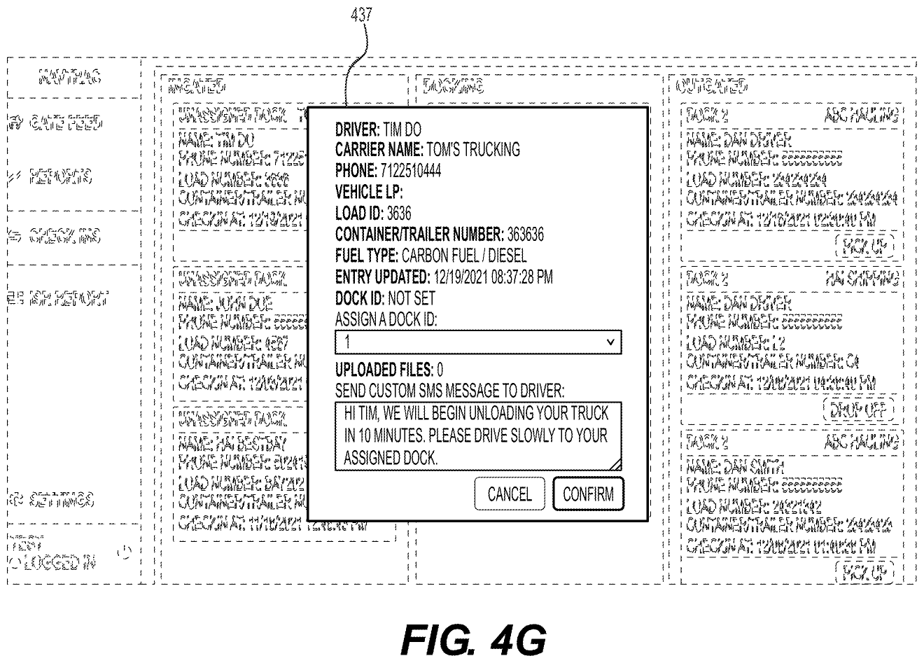

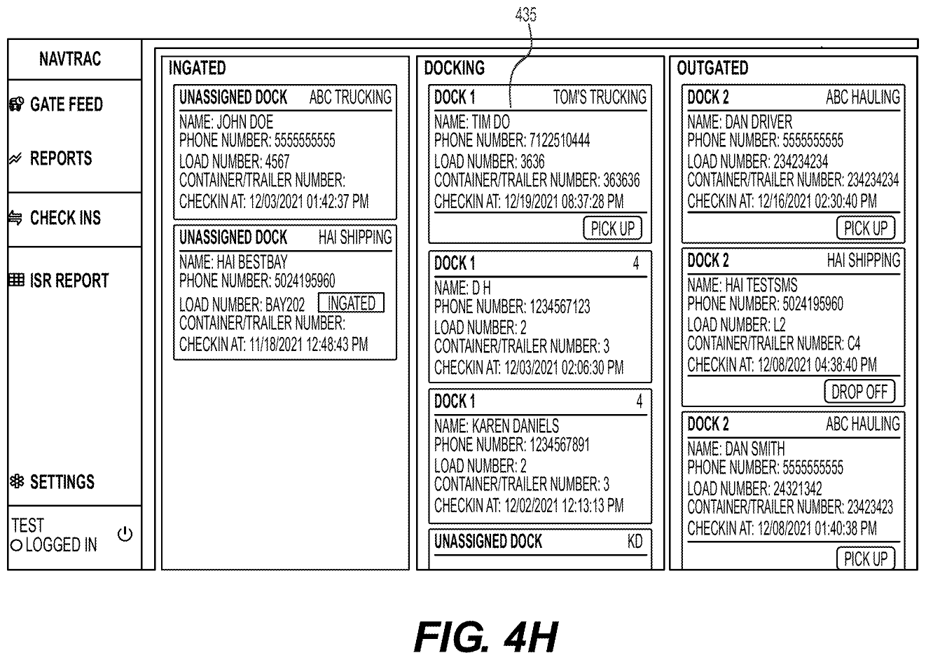

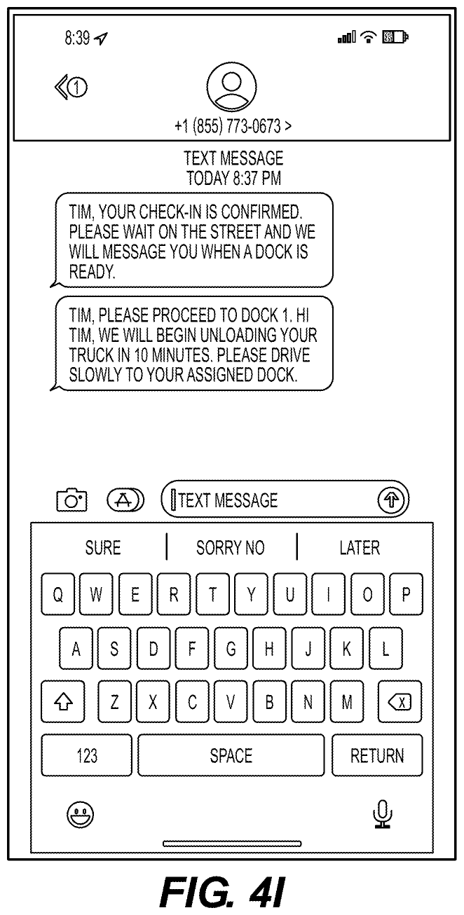

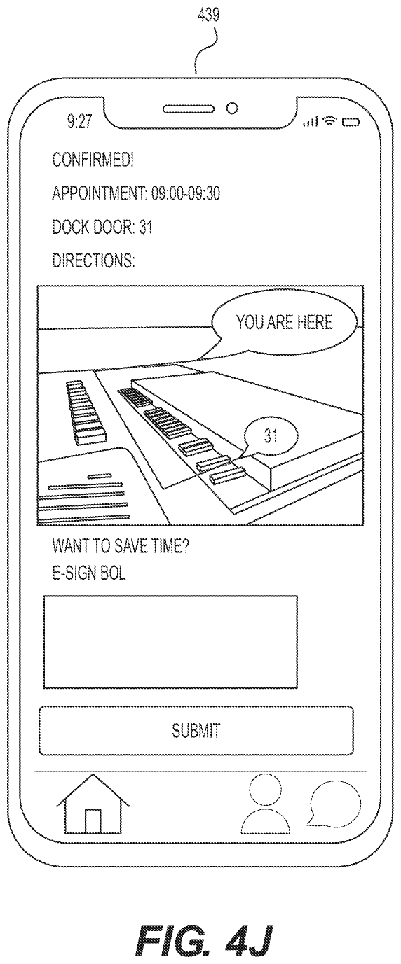

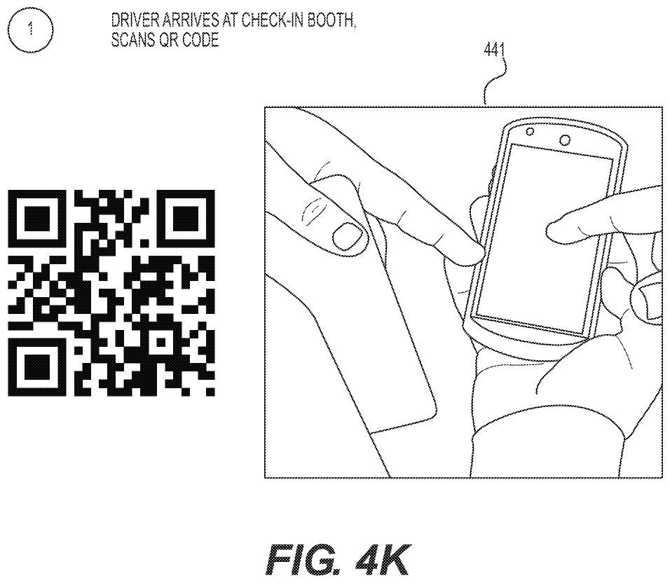

FIGS. 4A-4D are user interface diagrams that illustrate monitoring and recording incoming/outgoing vehicles to a warehouse facility, according to one embodiment. In FIG. 4A, system 100 may monitor, record, and categorize information of incoming or outgoing vehicles from warehouse facility 113. In one example embodiment, sensors 111 may capture a plurality of images/videos of incoming or outgoing vehicle 109. Machine learning system 115 may then save the captured images/videos in picture 403 of user interface 401. Machine learning system 115 may also store other information associated with incoming/outgoing vehicle 109, e.g., the date of arrival of vehicle 109 in date folder 405, time of arrival of vehicle 109 in time folder 407, the direction of vehicle 109 in direction folder 409, carrier information pertaining to vehicle 109 in carrier folder 411, license tag number of vehicle 109 in vehicle/truck folder 413, vehicle class information and fuel type information of vehicle 109 in vehicle folder 415, etc.

FIG. 4B depicts menu 417 to configure user interface 401, according to one embodiment. In one example embodiment, a user may select one or more items from menu 417, and system 100 may implement the selected items upon detecting an incoming vehicle to warehouse facility 113. In another embodiment, system 100 upon determining that user interface 401 has not been configured may implement a default setting or an automated setting to configure user interface 401. In one instance, during an automated setting, system 100 may select one or more items from menu 417 to configure user interface 401.

FIGS. 4C and 4D depict reports for warehouse facility 113, according to one embodiment. In one embodiment, reports 419 and 421 may be generated per schedule, on demand, periodically, or a combination thereof. In one example embodiment, reports 419 and 421 may include various information on the vehicles that visited warehouse facility 113. In one instance, the information may include the total number of vehicles that visited warehouse facility 113, date and time of arrival or departure of vehicle 109, chassis information, load information, vehicle make, fuel type information, etc.

FIG. 4E is an electronic user interface diagram that illustrates an online check-in process by a user, e.g., a driver, of at least one vehicle in the warehouse facility, according to one embodiment. In FIG. 4E, a user, e.g., a driver, of vehicle 109 may check-in online with system 100 to access warehouse facility 113 by entering his/her credentials, e.g., name and phone number, via user interface 423. Once the user submits the credentials by clicking a user interface element, e.g., next 425, the user may be navigated to a new interface 427. System 100 may then ask the user to enter load information associated with the transportation and delivery service, e.g., license plate/tag information, load ID, company name, security seal, and upload a picture of a bill of lading or driver's license, via user interface 427. When the user enters and submits the requested information, the user is navigated to a new interface 429. System 100 may request the user to enter fuel type for vehicle 109, e.g., gas mileage, emission information, etc., such information may be utilized by system 100 for vehicle classification. Once the user provides the fuel type for vehicle 109, system 100 generates interface 431 to notify the user that check-in is complete.

In one example embodiment, user equipment 101 may be used to perform navigation-related functions that can correspond to vehicle navigation, e.g., navigation to an allotted parking spot. This may be of particular benefit when used for navigating within spaces that may not have provisions for network connectivity or may have poor network connectivity, such as an indoor parking facility. As many parking facilities are multi-level concrete and steel structures, network connectivity and global positioning satellite availability may be low or non-existent. In such cases, locally stored data of the map database 119 regarding the parking spaces of warehouse facility 113 may be beneficial as identification of allotted parking spots in the parking space could be performed without requiring connection to a network or a positioning system. In such an embodiment, various other positioning methods could be used to provide vehicle reference positions within the parking facility, such as inertial measuring units, vehicle wheel sensors, compass, radio positioning means, etc.

In one embodiment, machine learning system 115 may assign a parking space to vehicle 109 based, at least in part, on task information associated with the vehicle. For example, machine learning system 115 may determine vehicle 109 is delivering goods to warehouse facility 113, and may assign a parking space that is closest to the delivery zone. In another embodiment, machine learning system 115 may assign a parking space to vehicle 109 based, at least in part, on vehicle type. For example, machine learning system 115 may determine vehicle 109 is an electric vehicle and may assign a parking space with a charging station. In a further embodiment, machine learning system 115 may assign a parking space to vehicle 109 based, at least in part, on vehicle specification, e.g., size and dimension information. For example, machine learning system 115 may determine vehicle 109 is a freight truck and may allot a parking space that is spacious to fit the freight truck.

In one embodiment, such check-in authenticator and routing solutions apply to self-driving autonomous vehicles. In one example embodiment, vehicle 109, e.g., self-driving autonomous vehicles, enters the premises of warehouse facility 113, whereupon the system of vehicle 109, e.g., various software applications, automatically connects, via communication network 107, to machine learning system 115 and/or computer vision system 117. Computer vision system 117 may inspect vehicle 109 based on the stored vehicle specifications, e.g., vehicle make, vehicle color, vehicle type, number plate, etc., to authenticate vehicle 109 for entry to warehouse facility 113. Machine learning system 115 may then provide specific coordinates to navigate authenticated vehicle 109 within warehouse facility 113 towards their allotted parking space, e.g., parking space with a charging station. In one embodiment, machine learning system 115 may monitor, in real-time or near real-time, vehicle 109 within warehouse facility 113 for their current position, e.g., duration of stay, and any other diagnostic information, e.g., battery charge, tire pressure, fluid levels, vehicle condition, etc. Machine learning system 115 may provide specific instructions to vehicle 109 regarding the time of departure from the allotted parking space, and vehicle 109 departs the allotted parking space.

In another embodiment, one or more users may reserve a parking space via user interfaces on their respective user equipment 101. FIGS. 4F-4I are user interface diagrams that illustrate an online process for assigning a parking space for a vehicle of a checked-in driver, according to one embodiment. FIG. 4F depicts a user interface that displays a plurality of information cards of checked-in drivers in user equipment 101 of the operator of warehouse facility 113. In one example embodiment, information card 435 includes information on the checked-in users, e.g., names, phone numbers, etc. Information card 435 also includes information on vehicles 109 of the checked-in users, e.g., load numbers, container/trailer numbers, check-in time, etc. Information card 435 further includes a user interface element that indicates whether vehicle 109 has been assigned parking space, e.g., dock. In this example embodiment, information card 435 shows that vehicle 109 of the checked-in user has not been assigned parking space.

In FIG. 4G, the operator assigns vehicle 109 of the checked-in driver a parking space via user interface 437. In one embodiment, the parking space may be assigned based, at least in part, on the availability of the parking space, the task of the driver, vehicle specifications, vehicle type, or a combination thereof. While assigning a parking space, the operator may also input instructions to the driver, and such instructions may be in a textual or aural format. Once the parking space is allocated, the position of information card 435 is automatically moved from “ingated” to “docking” (as shown in FIG. 4F). The completion of the parking assignment may automatically trigger transmission of an SMS text to user equipment 101 of the checked-in driver. The SMS text may include specific information regarding parking, e.g., navigation information, location information, etc. (as depicted in FIG. 4I). The operator and the driver can communicate via text through this channel.

Subsequently, the user receives a notification, e.g., interface 439, regarding confirmation of an appointment to access warehouse facility 113. The notification includes temporal information, location information, navigation information, or a combination thereof (as shown in FIG. 4J). For example, system 100 may generate audio-visual navigation guidance towards the assigned location in the warehouse facility. Upon arrival at the main entrance of warehouse facility 113, the driver may scan a QR code to authenticate his or her identity and enter load information associated with the transportation and delivery service, e.g., license plate/tag information, load ID, company name, security seal, and upload a picture of a bill of lading or driver's license, via user interface 441 and to gain access to warehouse facility 113 (as shown in FIG. 4K).

FIG. 5 illustrates an implementation of a general computer system that may execute techniques presented herein. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 500 may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 500 can be implemented using electronic devices that provide voice, video, or data communication. Further, while a computer system 500 is illustrated as a single system, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. The processor 502 may be a component in a variety of systems. For example, the processor 502 may be part of a standard personal computer or a workstation. The processor 502 may be one or more general processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The computer system 500 may include a memory 504 that can communicate via a bus 508. The memory 504 may be a main memory, a static memory, or a dynamic memory. The memory 504 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 504 includes a cache or random-access memory for the processor 502. In alternative implementations, the memory 504 is separate from the processor 502, such as a cache memory of a processor, the system memory, or other memory. The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described herein may be performed by the processor 502 executing the instructions stored in the memory 504. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 500 may further include a display 510, such as a liquid crystal display (LCD), an organic light emitting diode (OLED), a flat panel display, a solid-state display, a cathode ray tube (CRT), a projector, a printer or other now known or later developed display device for outputting determined information. The display 510 may act as an interface for the user to see the functioning of the processor 502, or specifically as an interface with the software stored in the memory 504 or in the drive unit 506.

Additionally or alternatively, the computer system 500 may include an input/output device 512 configured to allow a user to interact with any of the components of computer system 500. The input/output device 512 may be a number pad, a keyboard, or a cursor control device, such as a mouse, or a joystick, touch screen display, remote control, or any other device operative to interact with the computer system 500.

The computer system 500 may also or alternatively include drive unit 506 implemented as a disk or optical drive. The drive unit 506 may include a computer-readable medium 522 in which one or more sets of instructions 524, e.g. software, can be embedded. Further, instructions 524 may embody one or more of the methods or logic as described herein. The instructions 524 may reside completely or partially within the memory 504 and/or within the processor 502 during execution by the computer system 500. The memory 504 and the processor 502 also may include computer-readable media as discussed above.

In some systems, a computer-readable medium 522 includes instructions 524 or receives and executes instructions 524 responsive to a propagated signal so that a device connected to a network 570 can communicate voice, video, audio, images, or any other data over the network 570. Further, the instructions 524 may be transmitted or received over the network 570 via a communication port or interface 520, and/or using a bus 508. The communication port or interface 520 may be a part of the processor 502 or may be a separate component. The communication port or interface 520 may be created in software or may be a physical connection in hardware. The communication port or interface 520 may be configured to connect with a network 570, external media, the display 510, or any other components in computer system 500, or combinations thereof. The connection with the network 570 may be a physical connection, such as a wired Ethernet connection or may be established wirelessly as discussed below. Likewise, the additional connections with other components of the computer system 500 may be physical connections or may be established wirelessly. The network 570 may alternatively be directly connected to a bus 508.

While the computer-readable medium 522 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 522 may be non-transitory, and may be tangible.

The computer-readable medium 522 can include a solid-state memory such as a memory card or other package that houses one or more non-volatile read-only memories. The computer-readable medium 522 can be a random-access memory or other volatile re-writable memory. Additionally or alternatively, the computer-readable medium 522 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 500 may be connected to a network 570. The network 570 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 570 may include wide area networks (WAN), such as the Internet, local area networks (LAN), campus area networks, metropolitan area networks, a direct connection such as through a Universal Serial Bus (USB) port, or any other networks that may allow for data communication. The network 570 may be configured to couple one computing device to another computing device to enable communication of data between the devices. The network 570 may generally be enabled to employ any form of machine-readable media for communicating information from one device to another. The network 570 may include communication methods by which information may travel between computing devices. The network 570 may be divided into sub-networks. The sub-networks may allow access to all of the other components connected thereto or the sub-networks may restrict access between the components. The network 570 may be regarded as a public or private network connection and may include, for example, a virtual private network or an encryption or other security mechanism employed over the public Internet, or the like.

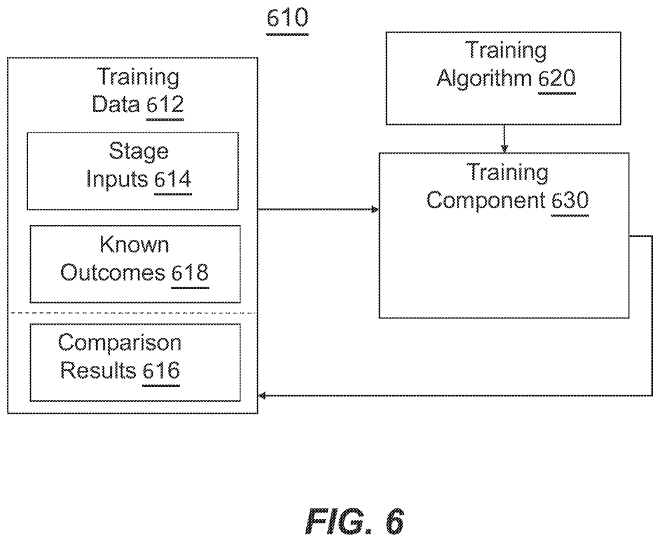

One or more implementations disclosed herein include and/or may be implemented using a machine learning model. For example, one or more of monitoring module 201, matching module 203, categorization module 205, training module 207, prediction module 209, and user interface module 211 may be implemented using a machine learning model and/or may be used to train a machine learning model. A given machine learning model may be trained using the data flow 610 of FIG. 6. Training data 612 may include one or more of stage inputs 614 and known outcomes 618 related to a machine learning model to be trained. The stage inputs 614 may be from any applicable source including text, visual representations, data, values, comparisons, stage outputs (e.g., one or more outputs from a step from FIGS. 1, 2, 3A-3L, and/or 4A-4K). The known outcomes 618 may be included for machine learning models generated based on supervised or semi-supervised training. An unsupervised machine learning model may not be trained using known outcomes 618. Known outcomes 618 may include known or desired outputs for future inputs similar to or in the same category as stage inputs 614 that do not have corresponding known outputs.

The training data 612 and a training algorithm 620 (e.g., monitoring module 201, matching module 203, categorization module 205, training module 207, prediction module 209, and user interface module 211 implemented using a machine learning model and/or may be used to train a machine learning model) may be provided to a training component 630 that may apply the training data 612 to the training algorithm 620 to generate a machine learning model. According to an implementation, the training component 630 may be provided comparison results 616 that compare a previous output of the corresponding machine learning model to apply the previous result to re-train the machine learning model. The comparison results 616 may be used by the training component 630 to update the corresponding machine learning model. The training algorithm 620 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like.

A machine learning model used herein may be trained and/or used by adjusting one or more weights and/or one or more layers of the machine learning model. For example, during training, a given weight may be adjusted (e.g., increased, decreased, removed) based on training data or input data. Similarly, a layer may be updated, added, or removed based on training data/and or input data. The resulting outputs may be adjusted based on the adjusted weights and/or layers.

In general, any process or operation discussed in this disclosure that is understood to be computer-implementable, such as the process illustrated in FIGS. 1, 2, 3A-3L, and/or 4A-4K may be performed by one or more processors of a computer system as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer-implemented method for automating management of a warehouse, comprising:
monitoring, in real-time, a plurality of items in the warehouse, a plurality of tasks associated with the warehouse, and/or incoming vehicles to the warehouse;
receiving, via a plurality of sensors, image data and/or video data associated with the plurality of items, the plurality of tasks, and/or the incoming vehicles, wherein the image data and/or the video data indicates a change in position of at least one of the plurality of items, at least one incomplete task from the plurality of tasks, and/or a change in location of at least one of the incoming vehicles; and
inputting the image data and/or the video data into a machine learning model to automate the management of the warehouse, wherein the machine learning model has been trained based on training data to generate predictions for the inputted data, and wherein the machine learning model utilizes the predictions for the inputted data for retraining to generate predictions for newly inputted data and improve accuracy of error handling.

2. The computer-implemented method of claim 1, further comprising: detecting, in real-time, probe data of the incoming vehicles to predict time of arrival at the warehouse;
retrieving data associated with the incoming vehicles from a database, wherein the retrieved data includes license plate data, vehicle attributes, and/or identification information of drivers of the incoming vehicles; and
comparing the image data and/or the video data associated with the incoming vehicles with the retrieved data to determine a match for authenticating the incoming vehicles to enter the warehouse.

3. The computer-implemented method of claim 2, further comprising:
determining operating condition of the incoming vehicles based, at least in part, on the image data, the video data, and/or other data associated with the incoming vehicles, wherein the other data indicates usage statistics, maintenance data, and/or wear and tear on components of the incoming vehicles; and
generating a notification in user interfaces of devices associated with the drivers of the incoming vehicles, wherein the notification includes a recommendation for maintenance of the incoming vehicles before performing a next assignment.

4. The computer-implemented method of claim 2, further comprising:
generating one or more reports on the incoming vehicles per schedule, on demand, or periodically, wherein the reports include total number of vehicles that visited the warehouse, date and time of arrival or departure of the incoming vehicles, chassis information, load information, vehicle type, and/or fuel type information.

5. The computer-implemented method of claim 2, further comprising:
generating at least one user interface in devices associated with the drivers of the incoming vehicles for verifying the drivers, wherein the drivers are requested login credentials,
automatically assigning parking spaces to the incoming vehicles based, at least in part, on task information, vehicle type, and/or dimension information; and
generating a navigation element in the user interface of the devices to navigate the drivers toward the assigned parking spaces in the warehouse.

6. The computer-implemented method of claim 1, further comprising:
determining inventory status based, at least in part, on the monitoring of the plurality of items in the warehouse, wherein the inventory status indicates total items in the warehouse, location of each of the plurality of items in the warehouse, and capacity of the warehouse to store additional items.

7. The computer-implemented method of claim 6, further comprising:
generating a recommendation for correctly positioning one or more misplaced items in the warehouse based, at least in part, on detecting the one or more items are incorrectly placed in the warehouse; or
generating a recommendation for prioritizing one or more incomplete tasks to prevent additional delays based, at least in part, upon determining the one or more tasks have not been completed per schedule.

8. The computer-implemented method of claim 1, further comprising:
segmenting the image data and/or the video data into a plurality of regions; and identifying objects in the segmented plurality of regions to classify the objects to a pre-defined category.

9. The computer-implemented method of claim 1, wherein a supervised learning is utilized to train the machine learning model, and wherein the supervised learning applies a set of known input data and known responses to the input data to train the machine learning model.

10. The computer-implemented method of claim 1, wherein the plurality of sensors collect the image data and/or the video data in real-time, per demand, according to a set schedule, in response to one or more activities detected in a particular area of the warehouse, or a combination thereof.

11. A system for automating management of a warehouse, comprising:
one or more processors; and
a non-transitory computer readable medium storing instructions that, when executed by the one or more processors, cause the one or more processors to perform a method comprising:
monitoring, in real-time, a plurality of items in the warehouse, a plurality of tasks associated with the warehouse, and/or incoming vehicles to the warehouse;
receiving, via a plurality of sensors, image data and/or video data associated with the plurality of items, the plurality of tasks, and/or the incoming vehicles, wherein the image data and/or the video data indicates a change in position of at least one of the plurality of items, at least one incomplete task from the plurality of tasks, and/or a change in location of at least one of the incoming vehicles; and
inputting the image data and/or the video data into a machine learning model to automate the management of the warehouse, wherein the machine learning model has been trained based on training data to generate predictions for the inputted data, and wherein the machine learning model utilizes the predictions for the inputted data for retraining to generate predictions for newly inputted data and improve accuracy of error handling.

12. The system of claim 11, further comprising:
detecting, in real-time, probe data of the incoming vehicles to predict time of arrival at the warehouse;
retrieving data associated with the incoming vehicles from a database, wherein the retrieved data includes license plate data, vehicle attributes, and/or identification information of drivers of the incoming vehicles; and
comparing the image data and/or the video data associated with the incoming vehicles with the retrieved data to determine a match for authenticating the incoming vehicles to enter the warehouse.

13. The system of claim 12, further comprising:
determining operating condition of the incoming vehicles based, at least in part, on the image data, the video data, and/or other data associated with the incoming vehicles, wherein the other data indicates usage statistics, maintenance data, and/or wear and tear on components of the incoming vehicles; and
generating a notification in user interfaces of devices associated with the drivers of the incoming vehicles, wherein the notification includes a recommendation for maintenance of the incoming vehicles before performing a next assignment.

14. The system of claim 12, further comprising:
generating one or more reports on the incoming vehicles per schedule, on demand, or periodically, wherein the reports include total number of vehicles that visited the warehouse, date and time of arrival or departure of the incoming vehicles, chassis information, load information, vehicle type, and/or fuel type information.

15. The system of claim 12, further comprising:
generating at least one user interface in devices associated with the drivers of the incoming vehicles for verifying the drivers, wherein the drivers are requested login credentials,
automatically assigning parking spaces to the incoming vehicles based, at least in part, on task information, vehicle type, and/or dimension information; and
generating a navigation element in the user interface of the devices to navigate the drivers toward the assigned parking spaces in the warehouse.

16. The system of claim 11, further comprising:
determining inventory status based, at least in part, on the monitoring of the plurality of items in the warehouse, wherein the inventory status indicates total items in the warehouse, location of each of the plurality of items in the warehouse, and capacity of the warehouse to store additional items.

17. The system of claim 16, further comprising:
generating a recommendation for correctly positioning one or more misplaced items in the warehouse based, at least in part, on detecting the one or more items are incorrectly placed in the warehouse; or
generating a recommendation for prioritizing one or more incomplete tasks to prevent additional delays based, at least in part, upon determining the one or more tasks have not been completed per schedule.

18. A non-transitory computer-readable medium storing instructions for automating management of a warehouse, the instructions, when executed by one or more processors, causing the one or more processors to perform operations comprising:
monitoring, in real-time, a plurality of items in the warehouse, a plurality of tasks associated with the warehouse, and/or incoming vehicles to the warehouse;
receiving, via a plurality of sensors, image data and/or video data associated with the plurality of items, the plurality of tasks, and/or the incoming vehicles, wherein the image data and/or the video data indicates a change in position of at least one of the plurality of items, at least one incomplete task from the plurality of tasks, and/or a change in location of at least one of the incoming vehicles; and
inputting the image data and/or the video data into a machine learning model to automate the management of the warehouse, wherein the machine learning model has been trained based on training data to generate predictions for the inputted data, and wherein the machine learning model utilizes the predictions for the inputted data for retraining to generate predictions for newly inputted data and improve accuracy of error handling.

19. The non-transitory computer-readable medium of claim 18, further comprising:
detecting, in real-time, probe data of the incoming vehicles to predict time of arrival at the warehouse;
retrieving data associated with the incoming vehicles from a database, wherein the retrieved data includes license plate data, vehicle attributes, and/or identification information of drivers of the incoming vehicles; and
comparing the image data and/or the video data associated with the incoming vehicles with the retrieved data to determine a match for authenticating the incoming vehicles to enter the warehouse.

20. The non-transitory computer-readable medium of claim 19, further comprising:
determining operating condition of the incoming vehicles based, at least in part, on the image data, the video data, and/or other data associated with the incoming vehicles, wherein the other data indicates usage statistics, maintenance data, and/or wear and tear on components of the incoming vehicles; and
generating a notification in user interfaces of devices associated with the drivers of the incoming vehicles, wherein the notification includes a recommendation for maintenance of the incoming vehicles before performing a next assignment.
